(19) United States
(12) Patent Application Publication
(10) Pub. No.: US 2019/0025657 A1
(43) Pub. Date: Jan. 24, 2019

(54) LIQUID CRYSTAL BEAM CONTROL DEVICE

(71) Applicant: LENSVECTOR INC., San Jose, CA (US)

(72) Inventors: Vladimir PRESNIAKOV, Quebec (CA); Karen ASATRYAN, Quebec (CA); Armen ZOHRABYAN, Quebec (CA); Tigran GALSTIAN, Quebec (CA); Aram BAGRAMYAN, Quebec (CA); Simon CAREAU, Quebec (CA)

(21) Appl. No.: 15/757,471

(22) PCT Filed: May 25, 2016
(86) PCT No.: PCT/CA2016/050589

§ 371 Date: Mar. 5, 2018

Related U.S. Application Data
(60) Provisional application No. 62/217,875, filed on Sep. 12, 2015.
(60) Provisional application No. 62/242,422, filed on Oct. 16, 2015.

(51) Int. Cl. G02F 1/1343; G02F 1/1337; G02F 1/1335

(52) U.S. Cl. CPC G02F 1/134363; G02F 1/1337; G02F 1/133528; G02F 1/133504; G02F 2201/122; G02F 2203/26; G02F 2001/133742; G02F 2203/06; G02F 1/13439

(57) ABSTRACT

Liquid crystal light beam control devices and their manufacture are described. Beneficial aspects of beam broadening devices employed for controlled illumination and architectural purposes are presented including improving beam divergence control, improving beam broadening dynamic range control, beam divergence preconditioning, improving projected beam intensity uniformity and reducing color separation in the projected beam. Both beam control devices having in-plane and homeotropic ground state liquid crystal alignment are presented.

### RELATED APPLICATIONS

This patent application claims priority from U.S. Provisional Patent Application Ser. No. U.S. 62/217,875 filed Sep. 12, 2015 and from U.S. Provisional Patent Application Ser. No. U.S. 62/242,422 filed Oct. 16, 2015, the entireties of which are incorporated herein by reference.

### TECHNICAL FIELD

This patent application relates to liquid crystal beam control devices and their manufacturing.

### BACKGROUND

Liquid crystal beam control devices are known in the art. Some such devices typically use patterned electrodes over a liquid crystal cell to create a spatial variation in the index of refraction that is useful to control a beam. To keep voltages low, electrodes can be placed on cell substrates on an inner side or sides thereof. To increase optical performance, the (form factor) size and/or aspect ratio of beam (control) shaping elements, defined mainly by the ratio of the patterned electrodes pitch and the thickness of the liquid crystal, should be relatively small. Various problems exist, including: a limited degree (extent) of angular control, poor (quality) beam intensity distribution, excessive color separation, high cost of manufacture, unsuitable operation voltage, etc.

However, now specific applications are emerging that might benefit from such elements. There are many examples of such applications, which may be qualified as “dynamic” or “smart” lighting. For example, Light Emitting Diode (LED) sources are increasingly used in the architectural lighting, automotive industry, etc., but in the large majority of cases the parameters of those illumination systems (such as diffusion, divergence, glares, direction, etc.) are fixed. At the same time, it might be extremely useful, for example, to have a lighting system that might change the divergence angle of the LED illumination system automatically when there is a car moving in the opposed direction (to avoid disturbing its driver). Other examples may be mentioned for optimized residential or general architectural lighting. In addition, with the penetration of Li-Fi technologies (replacing the Wi-Fi by smart LED sources) the ability to controllably to steer or broaden light (used both for illumination and connectivity) may be very useful. This is a reason why liquid crystal beam control devices become increasingly important.

### SUMMARY

Applicant has discovered a number of characteristics related to the optical performance of beam shaping liquid crystal devices.

Such devices typically use patterned electrodes arranged at one or both sides of a liquid crystal layer to create a spatial variation in the index of refraction (by electric field induced molecular reorientation) that is useful to control a light beam (FIGS. 17A, 17B, 17C). Usually the efficiency of beam shaping is defined by the optical path difference (or the phase delay δϕ=L·δn·2π/κ, where L is the effective thickness, δn is the electrically induced refractive index difference and λ is the light wavelength in vacuum) undergone by light traversing the liquid crystal layer. This difference is limited by the maximal values of optical birefringence Δn (δn<Δn) and the thickness L of the liquid crystal. The beam shaping efficiency is also inversely proportional to the clear aperture (CA) of the element that is defined by the gap g between various electrode segments. Thus the ratio r=δϕ/CA is one of the important factors (it contains also the aspect ratio L/CA or L/g). That is the reason why relatively thick liquid crystal layers and relatively small gaps g may be used to increase the efficiency of beam shaping. Multiple such segments may be combined to “fill” the clear aperture of large beam shaping devices. One application of such beam shaping devices is for lighting in which the light from a light source, such as a beam from an LED light source, can be modulated from a spot beam to a slit or fan beam and/or to a broad flood beam.

To keep working voltages lower, electrodes are usually placed on the cell substrates on the inner side or sides. However, the simple physical parameters of the element (the aspect ratio, birefringence, etc.) are not the only determining factors. The refractive index modulation depth (efficiency) will also dramatically depend upon the way various electrode segments are excited. Thus, FIG. 18A schematically illustrates a 3D and FIG. 18B illustrates a cross-section view of a cylindrical liquid crystal focusing element (lens), where the liquid crystal 3 is confined between two linear (independently controlled) electrodes 1 and 2 (along the x axis) from the top and a uniform transparent electrode 4 from the bottom. As schematically illustrated, the electric field profile may be quite different if the same voltage (amplitude and phase) is applied between electrodes 1 and 2 with the opposed uniform electrode 4 grounded as illustrated in FIG. 19A (which is detail view of FIG. 1) versus the implementation in which electrodes 1 and 2 are excited by different voltages or different phases as illustrated in FIG. 19B (which is a detail view of FIG. 2). In the later implementation the uniform electrode 4 illustrated in FIGS. 18A, 18B and 19A (FIG. 1) may even be omitted to make the difference more striking as illustrated in FIG. 19B (FIG. 2). The field profile 8 being different, the induced liquid crystal alignment (and thus the refractive index profile) also will be different. The ground state orientation of liquid crystal molecules provided by alignment layers 7 (which are omitted from the other figures for ease of illustration of the concepts herein) is also a very important factor (see hereafter). Those elements will substantially affect the beam shaping efficiency.

One discovery is that the optical performance of at least some of the proposed devices can be dependent on the propagation direction of light through the device (light propagation). For example, top to bottom propagation 25 versus bottom to top propagation 26 can result in output beams having differing optical properties and/or characteristics when the electric field employed is different between near one substrate and near the other (typically opposite) substrate of the liquid crystal cell employed in the device. Surprisingly, measured optical property and/or characteristics differences due to propagation direction (travel) through the device can be very significant for certain layer geometries or device designs. Given that optical properties of ordinary homogenous materials are fundamentally reciprocal according to Maxwell's equations, this dependence on direction of propagation is not an obvious discovery. While some of these discovered effects can be understood, it is surprising that such effects express large measurable variations. Some of the embodiments of the proposed solution take advantage of, and employ, such effects in small form factor devices for various applications.

Applicant has also discovered that selection of liquid crystal ground state alignment and selection of an aspect ratio of patterned electrode element spacing to cell thickness can result in useful (effective) beam control when using patterned electrodes on the same substrate. Such electrodes provide an electric field between element electrodes across the spacing (along the substrate) and within the LC volume adjacent to the element electrodes in the cell gap. Such beam control can be provided free of “hot spots”, namely the outward propagating output beam “exiting” the device can have a substantially uniform intensity distribution as a function of angle of/within the output beam. Applicant has further discovered, and provides a characterization of, the influence of ground state alignment of the liquid crystal on the performance of such LC cells.

For a beam control device which controls beam divergence by adding or creating divergence in a less divergent beam, applicant has further discovered that color separation in a liquid crystal beam control device can be greater for a spectrally broad incident light beam that is collimated than for a similar broadband incident light beam that is divergent. This discovery can be particularly useful for beam control applications where the least divergent incident beam desired available from a light source is not a collimated beam (light source is not a laser or the light source is not infinitely far away such as a celestial object). In such applications the output beam, provided by beam control devices in accordance with the proposed solution, can be controlled from lower divergence to higher divergence. For example, such a controlled dynamic range (of beam shaping) variation can be from about ±5 degree (full width half maximum) FWHM input divergence about the normal to about ≠30 degree FWHM output divergence about the normal. Comparatively, a collimated source beam incident on the liquid crystal cell of a similar beam shaping device controlled to provide about the same ±25 degree divergence FWHM (beam spread about the normal) at the output, would express greater color separation than in the case of the incident source beam being divergent to ±5 degrees FWHM and the output beam was controlled to be ±30 degree FWHM divergent.

Applicant has further discovered that color separation in a liquid crystal beam control device is dependent of in-plane liquid crystal molecular alignment orientation component with respect to the in-plane orientation of the (patterned) strip electrodes. Liquid crystal molecules have a molecular (major) axis. LC molecular alignment means can be employed in a LC cell to induce at least an initial ground state molecular alignment. Preferably a uniform ground state molecular alignment is desired to provide a coordinated operation of the LC material over the cell or effective device aperture. The general ground state molecular alignment direction, also referred to as a director, can be decomposed along x, y and z; “in-plane molecular alignment” as employed herein refers to the x, y director orientation disregarding the z component parallel to the propagation direction of the light beam through the beam control device. More specifically, when the in-plane LC alignment is oriented across the separation gap between strip (patterned) electrodes substantially perpendicularly to the strip electrodes, color separation in the output beam is much greater than when the in-plane LC alignment is at an angle, such as between about 45 degrees to about 0 degrees, namely substantially parallel to the (patterned) strip electrodes.

Applicant has further discovered that differently oriented (e.g. orthogonal) patterned electrode arrays can be arranged, with separation provided by a thin insulating layer, on a common substrate to provide “dual direction” beam control using a single layer of liquid crystal (for the same beam polarization affected by the LC layer). Such a device can provide beam control independently in each of the directions in addition to both directions combined.

Applicant has further discovered that the operation of a unit cell may become symmetrical if (structured) patterned electrodes are present on both substrates of the liquid crystal cell which can also enable steering operation in addition to beam broadening.

Applicant has further discovered that the aspect ratio of the liquid crystal element (and the broadening performance) may be greatly improved if the parallel electrodes at each surface are independent (interdigitated) and phase modulation control mode is used.

Applicant has further discovered that by using the phase modulation control mode one can generate a twisted molecular reorientation that may rotate the polarization of input light. This would allow the broadening of light in both planes in a much simpler (effective and low-cost) way.

Applicant has yet further discovered that patterned electrodes provided on opposed substrates of a liquid crystal cell can provide different beam control zones near each respective substrate. For example, using the simultaneous activation of all independent electrode lines (one pair at each surface) with phase shifted electric signals may enable the generation of twisted liquid crystal alignments along the thickness of the cell, in depth. This twisted alignment contributes to the partial rotation of the polarization direction of the input light (along with some partial change of the state of polarization).

In accordance with one aspect of the proposed solution there is provided a beam control device for shaping an output light beam, the beam control device being configured to receive an incident beam from a light source, the beam control device comprising: at least one liquid crystal cell for modulating said incident beam as said incident beam propagates therethrough, each liquid crystal cell having: a pair of cell substrates separated by a cell thickness, a liquid crystal material filling, at least one alignment layer for ordering said liquid crystal material with a director in a ground state alignment direction, and a patterned electrode structure having a pattern of paired electrodes on at least one of said pair of substrates for providing a spatially modulated electric field extending into said liquid crystal material, said liquid crystal cell having a predetermined aspect ratio between an electrode spacing gap between said paired electrodes and said cell thickness; said beam control device being characterized by a spatially modulated director reorientation when said patterned electrode structure is driven by a predetermined drive signal that provides said output beam that is broadened with good uniformity and low color separation, said incident light beam having a divergence between ±3 degrees FWHM and ±15 degrees FWHM, preferably between ±4 degrees FWHM and ±8 degrees FWHM.

In some embodiments the beam control device is arranged for said initial beam to enter a first one of said at least one liquid crystal cell by one of said substrates having said pattern of paired electrodes thereon, and said alignment layer provides an in-plane liquid crystal ground state alignment.

In some embodiments said alignment layer provides in-plane liquid crystal alignment having an alignment direction that is between about 45 degrees to 0 degrees with respect to an orientation of said electrodes in said electrode pairs.

In some embodiments at least a pair of alignment layers, each said alignment layer orienting said liquid crystal director with negative and positive pre-tilt out-of-plane angle on said opposed substrates, said patterned electrode structure being provided on both cell substrates and the beam control device performing in a symmetric manner irrespective of the substrate receiving said incident beam.

In some embodiments said patterned electrode structure comprises two electrically insulated electrode patterns having corresponding electrode pairs arranged substantially orthogonally to one another for providing beam shaping control in two directions or azimuthal planes.

In some embodiments said alignment layer provides in-plane liquid crystal alignment having an alignment direction that is about 45 degrees with respect to the orientation of said electrode pairs, and four of said liquid crystal cells are combined to provide modulation of both polarizations and in two directions or azimuthal planes.

In some embodiments at least two of said liquid crystal cells combined to provide output beam modulation in two directions or azimuthal planes, said beam control device is arranged such that said incident light beam enters a first one of said liquid crystal cells by one of said substrates having said patterned electrode structure thereon, said alignment layer of said first liquid crystal cell provides in-plane liquid crystal alignment, said beam control device is arranged for said beam output by said first liquid crystal cell to enter said second one of said liquid crystal cells by one of said substrates without said patterned electrode structure, said alignment layer of said second liquid crystal cell provides homeotropic liquid crystal alignment.

In some embodiments a pair of said liquid crystal cells are combined with another pair of said liquid crystal cells having a 90 degree polarization rotator element therebetween for beam modulation in two directions or azimuthal planes and both light polarizations.

In some embodiments at least two of said liquid crystal cells are combined and share a common intermediate substrate that is a sandwich of two substrates having facing sides each of which carries said electrode pattern covered by insulation and bonded together, said two substrates sandwich preferably being chemically thinned to reduce a thickness thereof without disrupting the electrode patterns.

In some embodiments said liquid crystal cell substrates containing a liquid crystal material, a first patterned electrode structure on said first one of said substrates having first independent electrodes for providing a first in-plane electric field at said first one of said substrates and a first spatial modulation of the liquid crystal material in a first zone near said first substrate and between said first independent electrodes of said first patterned electrode structure, and a second patterned electrode structure arranged at a cross-orientation with respect to said first patterned electrode structure on a second one of said substrates and having second independent electrodes for providing a second in-plane electric field at said second one of said substrates and a second spatial modulation of the liquid crystal material in a second zone near said second substrate and between said second independent electrodes of said second patterned electrode structure, wherein when said first and said second patterned electrode structures are powered, a twist in liquid crystal orientation arises in a third zone between said first zone and said second zone over at least a portion of an aperture of said device to provide a polarization rotation in light passing through said device.

In some implementations the beam control device includes an incident beam conditioning component including one of: a convergence adding optical element when said light source comprises a divergent light source providing an initial beam divergence greater than ±8 degrees FWHM; a divergence adding optical element when said light source comprises a collimated light source providing a; and a dynamic diffuser.

In some implementations the beam control device includes an output beam conditioning component including one of: diffuser; and a second one of said beam control devices oriented with respect to the first beam control devices at an angle between about ±2 degrees and about ±45 degrees.

In accordance with another aspect of the proposed solution there is provided a controllable beam shape light source module comprising a controllable light beam control module and a light source module providing said initial light beam, said light source module is one of a camera flash, an architectural, automobile or industrial lighting device

In accordance with another aspect of the proposed solution there is provided a controllable beam shape light source module comprising a controllable light beam control module and a light source module providing said initial light beam, said light source module is a scanner light source.

### BRIEF DESCRIPTION OF THE DRAWINGS

The embodiments will be better understood by way of the following detailed description with reference to the appended drawings, in which:

FIG. 1 is a schematic cross-section diagram illustrating a dynamic beam broadening optical device having a single patterned electrode with four beam shaping elements in a liquid crystal cell, device in which employs strip electrodes on one cell substrate and a planar electrode on an opposed substrate of the cell;

FIG. 2 is a schematic cross-section diagram illustrating a beam control optical device having four beam shaping elements in a liquid crystal cell, device which employs independent strip electrodes on one substrate of the cell to form an in-plane and fringe electric field between the electrodes;

FIG. 3A is a schematic cross-section diagram illustrating an enlarged view of a variant of one beam shaping element of the device illustrated in FIG. 2 in which the aspect ratio of strip electrode separation gap to cell (gap) thickness is large;

FIG. 3B is a schematic cross-section diagram illustrating an enlarged view of another variant of one beam shaping element of the device illustrated in FIG. 2 in which the aspect ratio of strip electrode separation gap to cell (gap) thickness is small;

FIG. 3C is a schematic cross-section diagram illustrating an enlarged view of yet another variant of one beam shaping element of the device illustrated in FIG. 2 with an aspect ratio that is suitable for beam broadening in accordance with the proposed solution;

FIG. 3D is a schematic plot of experimentally measured beam intensity as a function of projection angle for the same input beam with: no device, and then with the cell of the device operating at 0V, 2V, 3V, 4V, 5V, 6V, 7V and 8V, from which it can be seen that an appropriately (pre)selected (liquid crystal in-plane alignment and) aspect ratio for the cell of FIG. 3C can provide (even) beam broadening at low voltage having an improved beam intensity uniformity in accordance with the proposed solution;

FIG. 4A is a schematic diagram illustrating a plan view of a beam control element according to FIG. 3C in which in-plane liquid crystal alignment is substantially parallel to the strip electrodes in accordance with the proposed solution;

FIG. 4B is a schematic diagram illustrating a cross-section of a beam control optical device having four beam shaping elements within a liquid crystal cell employing strip electrodes on one substrate of the cell to form an in-plane and fringe electric field between the electrodes, with strip electrodes registered to opposed strip electrodes provided on an opposite cell substrate in accordance with the proposed solution;

FIG. 4C is a schematic diagram illustrating a cross-section of a beam control optical device having four beam shaping elements within a liquid crystal cell employing strip electrodes on one substrate of the cell to form an in-plane and fringe electric field between the electrodes, with strip electrodes offset with respect to interdigitating (middle) strip electrodes provided on an opposed cell substrate in accordance with the proposed solution;

FIG. 5A is a schematic illustration of a projection of an output beam broadened using a device having a cell layered geometry according to FIG. 3C with the incident beam propagating through the device in the direction shown by arrow 26 in FIG. 3C, illustration showing a first amount of beam broadening in accordance with the proposed solution;

FIG. 5B is a schematic illustration of a projection of an output beam broadened using a device having a cell layered geometry according to FIG. 3C with the incident beam propagating through the device in the direction shown by arrow 25 in FIG. 3C, illustration showing a second amount of beam broadening in accordance with the proposed solution;

FIG. 5C is an image, and corresponding schematic color diagram inset, illustrating the projection of a beam broadened using a beam control device having a layered cell geometry according to FIG. 2, the image showing observed color separation;

FIG. 5D is an image, and corresponding schematic color diagram inset, illustrating the projection of a beam broadened using a beam control device having a layered cell geometry according to FIG. 4A, the image showing reduced color separation in accordance with the proposed solution;

FIG. 6 is a schematic diagram illustrating a beam control device having four LC cells arranged to provide dual polarization operation and two direction (along two azimuthal planes) beam control, configuration in which the in-plane liquid crystal orientation is substantially arranged at ±45 degrees to the orientation of the strip electrodes in accordance with the proposed solution;

FIG. 7 is a schematic diagram illustrating a beam control device having four LC cells arranged to provide dual polarization operation and two direction (along two azimuthal planes) beam control, configuration in which the liquid crystal orientation is mixed homeotropic (substantially parallel to the normal) and substantially parallel to the orientation of the strip electrodes in accordance with the proposed solution;

FIG. 8 is a schematic diagram illustrating a beam control device having four LC cells arranged to provide dual polarization operation and two direction (along two azimuthal planes) beam control, configuration in which the liquid crystal orientation is substantially parallel to the direction of the strip electrodes in the corresponding cell, the device employing a 90 degree polarization dynamic rotator element between the first two cells and the second two cells in accordance with the proposed solution;

FIG. 9 is a schematic diagram illustrating in plan view four beam control elements having orthogonally arranged and electrically isolated strip electrodes according to FIG. 3C in which (in plane) liquid crystal alignment is substantially at 45 degrees to the strip electrodes in accordance with the proposed solution;

FIGS. 10A, 10B, 10C and 10D are schematic plots illustrating four modulated beam projection patterns that can be obtained using the beam control device of FIG. 6 when the incident light is unpolarized and the rotator is a controlled element that can be adjusted not to rotate polarization in accordance with the proposed solution;

FIGS. 11A, 11B and 11C are images illustrating a beam broadened by a device according to FIG. 8 operated at 4V, 5V and 7V respectively in accordance with the proposed solution;

FIGS. 11D, 11E and 11F are images illustrating a beam broadened by a device similar to that of FIG. 6 having a parallel liquid crystal (in-plane) alignment with respect to one set of the electrode pairs operated at 4V, 5V and 7V respectively in accordance with the proposed solution;

FIGS. 11G, 11H and 11I are images illustrating a beam broadened by a device similar to that of FIG. 6 having homeotropic liquid crystal alignment operated at 4V, 5V and 7V respectively in accordance with the proposed solution;

FIG. 12A is a schematic block diagram of a beam controlled light source employing pre-conditioning collimation element and a dynamic liquid crystal beam control element in accordance with the proposed solution;

FIG. 12B is a schematic block diagram of a beam controlled light source employing pre-conditioning de-collimation element and a dynamic liquid crystal beam control element in accordance with the proposed solution;

FIG. 12C is an illustration of a (color, intensity) aberration reduction following source beam pre-conditioning in accordance with the proposed solution as illustrated in FIGS. 12A and 12B;

FIG. 12D is a schematic diagram illustrating another embodiment of the proposed solution in which a diffuser is employed after beam broadening of an LED source beam;

FIGS. 12E and 12F are illustrations of output broadened beam projections respectively without output diffuser and with output diffuser in accordance with the embodiment illustrated in FIG. 12D;

FIG. 12G is a schematic diagram illustrating a polarization independent two (azimuthal) plane beam broadening device employing sequential beam broadening devices, such that the first orthogonal polarization directions affected by the first beam broadening device are rotated at about 45 degrees with respect to the second orthogonal polarization directions affected by the subsequent second beam broadening device;

FIG. 13 is a schematic diagram illustrating in plan view an array of chirped strip electrodes having a spatially variable gap or spacing between the strip electrodes in accordance with the proposed solution;

FIG. 14A is a schematic diagram illustrating in plan view a centro-symmetric array of strip electrodes arranged concentrically in accordance with the proposed solution;

FIG. 14B is a schematic diagram illustrating in plan view a variant of a centro-symmetric array of strip electrodes arranged concentrically with staggered interconnections between rings in accordance with the proposed solution;

FIG. 15A is a schematic diagram illustrating in plan view a centro-symmetric array of radial electrodes that are complementary to the electrodes of FIG. 14A or 14B in accordance with the proposed solution;

FIG. 15B is a schematic diagram illustrating in plan view a variant of a centro-symmetric array of concentric (solid lines) and orthogonal radial (dashed lines) electrodes with essentially uniform electrode spacing by reduction of the number of radial electrodes going from outer rings to inner rings in accordance with the proposed solution;

FIG. 16A is a schematic plot of distributions of measured pixel intensity versus pixel location for collimated incident beams illustrating the intensity variation for red light and for blue light;

FIG. 16B is a schematic plot of distributions of measured pixel intensity versus pixel location for ±5 degree FWHM divergent incident beams illustrating the output beam intensity variation for red light and for blue light in accordance with the proposed solution;

FIG. 16C is a schematic plot of measured input beam intensity ratio between blue and red light as a function of pixel location for a collimated beam showing color separation;

FIG. 16D is a schematic plot of measured output beam intensity ratio between blue and red light as a function of pixel location for a ±5 degree FWHM divergent incident beam showing reduced color separation in accordance with the proposed solution;

FIGS. 17A, 17B and 17C are a schematic cross-section illustrations of the general concept of a liquid crystal based optical beam control device, in three different states, ground state FIG. 17A, excited to focus FIG. 17B and excited to defocus FIG. 17C;

FIGS. 18A and 18B are schematic 3D and cross-section illustrations, respectively, of a liquid crystal based optical beam control device (showing only 3 segments in FIG. 18A and one segment in FIG. 18B having independent or interdigitated parallel electrode strips 1 & 2 on one side of the LC cell and a uniform transparent electrode 4 on the opposite side in accordance with an embodiment of the proposed solution;

FIGS. 19A and 19B are schematic cross-sectional illustrations of the electric field profile differences in two liquid crystal based optical beam control devices (showing only one element in both cases), in FIG. 19A having one uniform transparent electrode 4 and connected (dependent) parallel electrode lines 1 & 2=1, and in FIG. 19B having only independent or interdigitated parallel electrode lines 1 & 2 from one side of the LC cell in accordance with an embodiment of the proposed solution;

FIG. 20 is a schematic (qualitative) demonstration of an operation mode that enables broadening and polarization transformation (mainly rotation) when both electrode layers are activated simultaneously in accordance with an embodiment of the proposed solution;

FIG. 21 is a schematic demonstration of the evolution of broadening and polarization characteristics of a light beam propagating in a final device (for broadening unpolarised light in two azimuthal planes) based on the discovered operation mode herein, in accordance with an embodiment of the proposed solution;

FIG. 22 is a schematic demonstration of cost effective final device (for broadening unpolarised light in two azimuthal planes) based on the discovered operation mode herein, in accordance with an embodiment of the proposed solution;

FIGS. 23A and 23B illustrate an experimental demonstration of beam broadening and polarization behavior of a beam of light when only one of the electrode layers is activated in accordance with an embodiment of the proposed solution;

FIG. 24 illustrates an experimental demonstration of beam broadening and polarization behavior of a beam of light when both of electrode layers are activated, in accordance with an embodiment of the proposed solution;

FIGS. 25A and 25B illustrate via experimental demonstrations the importance of having independent electrodes and applying the selected phase delays to obtain acceptable light broadening: in FIG. 25A all electrodes receive a drive signal having 5V in the same phase whereas in FIG. 25B all electrodes receive corresponding drive signals having 5V but their phases are changing to 0, 180, 90, 270 degrees respectively, in accordance with an embodiment of the proposed solution;

FIGS. 26A and 26B are schematic demonstrations of double layered electrode configuration wherein “pairs” of independently controlled electrodes are fabricated at different levels (separated by thin isolation layers): FIG. 26A illustrates a 3D schematic view of one beam control device element while FIG. 26B shows across sectional view of 3 adjacent elements arranged in accordance with an embodiment of the proposed solution;

FIG. 27 is schematic demonstration of a beam control device capable of broadening in one desired (azimuthal) plane only (or in the perpendicular azimuthal plane), and double broadening of the desired polarization component of light letting the perpendicular component remain unaffected in accordance with an embodiment of the proposed solution; and

FIG. 28A is a schematic plan view of substrates of a LC cell with “excited” twisted molecular reorientation (when all electrodes on opposed substrates are activated simultaneously and independently with different phases) which may be used to broaden unpolarized (natural) light in two (azimuthal) planes in accordance with an embodiment of the proposed solution; and

FIG. 28B is another schematic plan view of the substrates of another LC cell with “excited” twisted molecular reorientation (when all electrodes on opposed substrates are activated simultaneously and independently with different phases) which may be used to broaden unpolarized (natural) light in two (azimuthal) planes in accordance with an embodiment of the proposed solution.

While the layer sequence described is of significance, reference to “top”, “bottom”, “front” and “rear” qualifiers in the present specification is made solely with reference to the orientation of the drawings as presented in the application and do not imply any absolute spatial orientation.

### DETAILED DESCRIPTION

Beam control devices are optical devices which control a (refracted) output beam of light either with respect to the beam divergence or with respect to the beam direction (reorientation). Controlled beam divergence/convergence is a special case of beam control providing beam focussing/defocusing. Beam direction control can be employed for beam steering purposes. Beam control devices which provide a combination of beam diffusion, beam divergence/convergence or beam direction control are generally referred to herein as beam shaping devices.

In liquid crystal beam control devices, an electric field is typically used to control a molecular orientation of liquid crystal material in a LC cell. The electric field can be spatially modulated over the aperture of a liquid crystal optical device to spatially modulate the liquid crystal orientation. The change in molecular orientation affects the local index of refraction of the LC material and can create a refractive index gradient in the LC material throughout the LC cell volume. In a particular case, particular refractive index gradient variations can create what is known as gradient index (GRIN) lensing (including focusing or defocusing lensing). For lenses, it can be desirable to have a (controlled) smooth variation of LC molecular orientation over the aperture, without using numerous lens elements to form a lens of an extended aperture.

When the aperture of the beam control device is large, beam steering at large angles is difficult with a liquid crystal GRIN device due to relatively small variations in the index of refraction typically provided over the single aperture. By using a number of beam control elements having small active apertures over an effective larger aperture, smaller optical elements with a smaller aspect ratio (form factor) can provide greater overall beam steering ability. In the case of beam shaping devices, the use of a number of elements can be desirable and the profile of the electric field over the small aperture area of each beam shaping element and its interaction with the adjacent (shared) liquid crystal (material layer) can be different from that of larger aperture devices. In some implementations of the proposed solution, employing small form factor beam device elements can provide improved beam shaping, for example beam broadening.

In some beam control devices, the controlling electric field is provided using electrodes arranged on opposed sides of the liquid crystal layer, and in others, the electric field is provided by electrodes arranged on a single one substrate adjacent (containing/sandwiching) the liquid crystal layer.

Nematic liquid crystal when oriented in a ground state using a rubbed alignment layer (for in plane alignment) can affect only one polarization component of incident unpolarized light. To modulate unpolarized light, two, orthogonally oriented, layers of liquid crystal are commonly used. Natural or unpolarized light may be split into two orthogonal polarizations, only one of the polarizations will be modulated by the first LC layer (in accordance with its liquid crystal spatial modulation), while the other polarization component will essentially be unmodulated by that LC layer. The second LC layer arranged to provide the desired complementary modulation on the polarization unmodulated by the first LC layer, lets the polarization modulated by the first LC layer pass through with little negligible modulation.

### Beam Broadening

For specific beam shaping purposes, it is possible to program such liquid crystal double layer geometry, to also broaden a light beam in one or two perpendicular azimuthal planes (intersecting along the normal). The first liquid crystal layer can be employed to controllably spread light of one polarization in one direction, while a second liquid crystal layer can be employed to controllably spread light of the other polarization in an orthogonal direction.

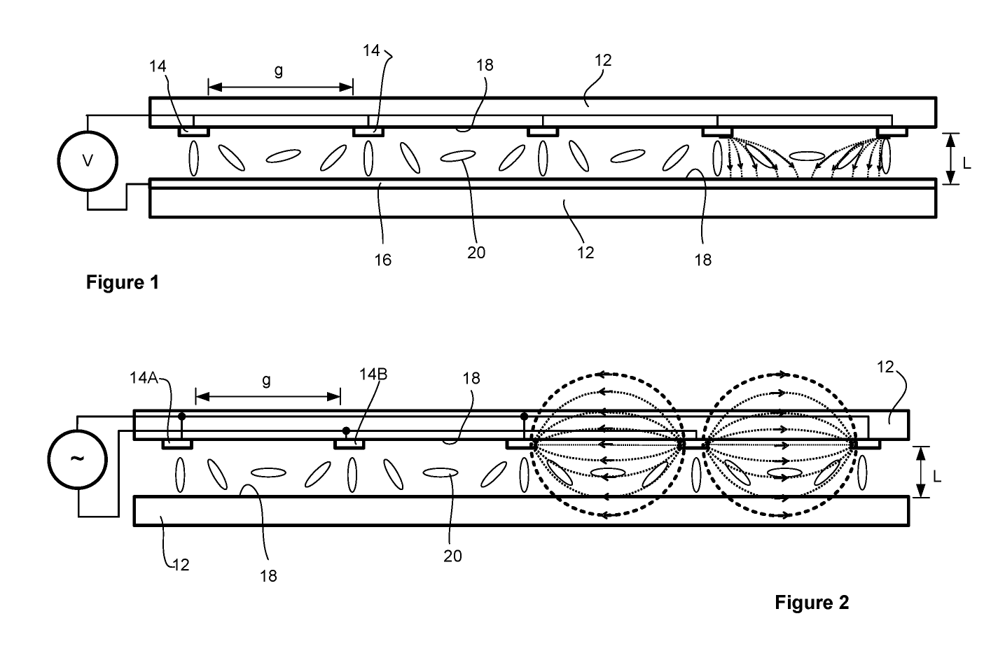

For example, the configuration of FIGS. 1 and 2 can provide devices that provide no light modulation under conditions of zero power, and then provide beam spreading or divergence when powered.

Such beam control can be better understood with reference to FIG. 1 which schematically illustrates a beam control device having a single liquid crystal layer 20 employing interconnected (commonly driven) parallel strip electrodes 14 on one substrate 12, the strip electrodes 14 being separated by an electrode separation gap g (spacing/pitch), and a transparent planar electrode 16 arranged on another opposed substrate 12 across the LC cell to provide a control electric field across the liquid crystal layer 20 having a thickness L (this thickness is sometimes known as the “cell gap”). Strip electrodes 14 can be transparent. Even if opaque or translucent, strip electrodes 14 are typically only 10 to 20 microns wide and would not otherwise block much light transmission. An alignment layer 18 (not shown in FIGS. 1 and 2 to have a thickness for ease of illustration), for example of a rubbed polymer, is provided over the internal surfaces preferably of both substrates 12 and over electrodes 14 and 16 to provide an initial ground state molecular orientation to the liquid crystal 20. Strip electrodes 14 are preferably provided on the substrate from which the incident light beam enters the LC cell, however the strip electrodes 14 can also be provided on the opposed substrate depending on the ground state alignment of the liquid crystal.

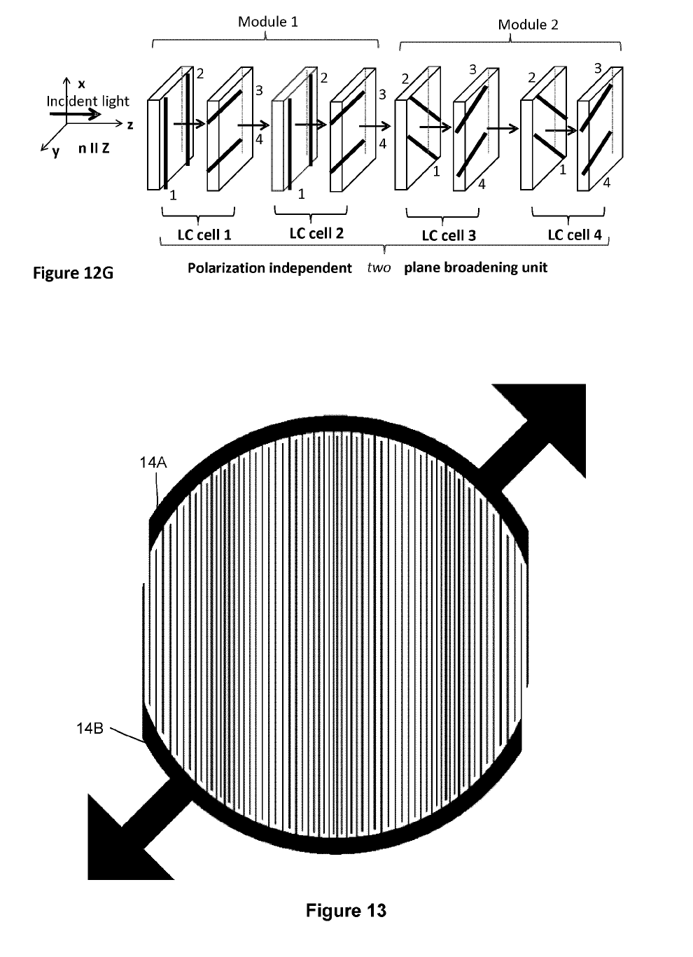

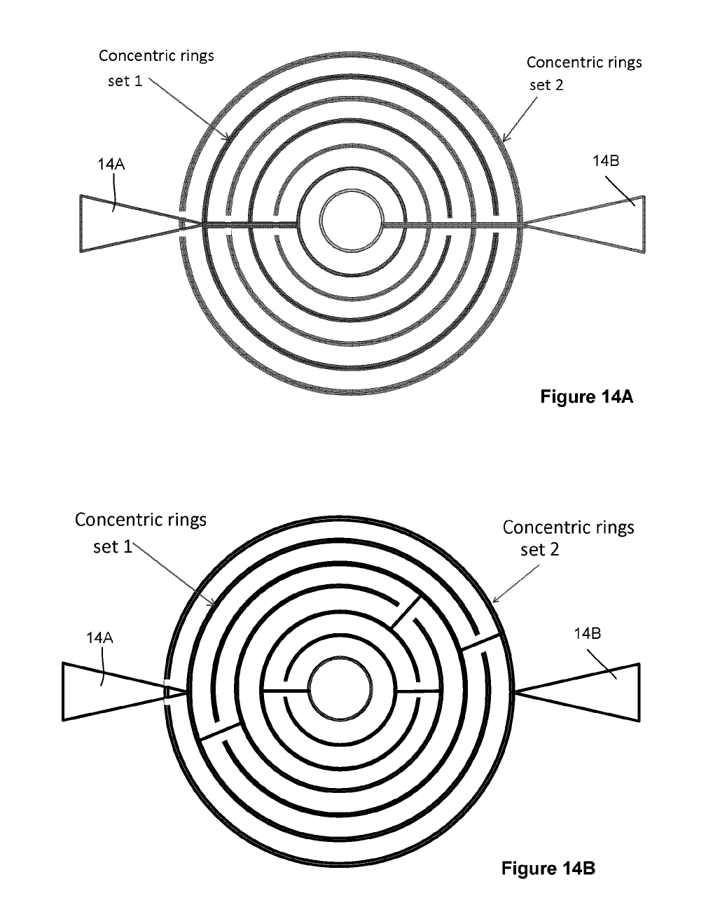

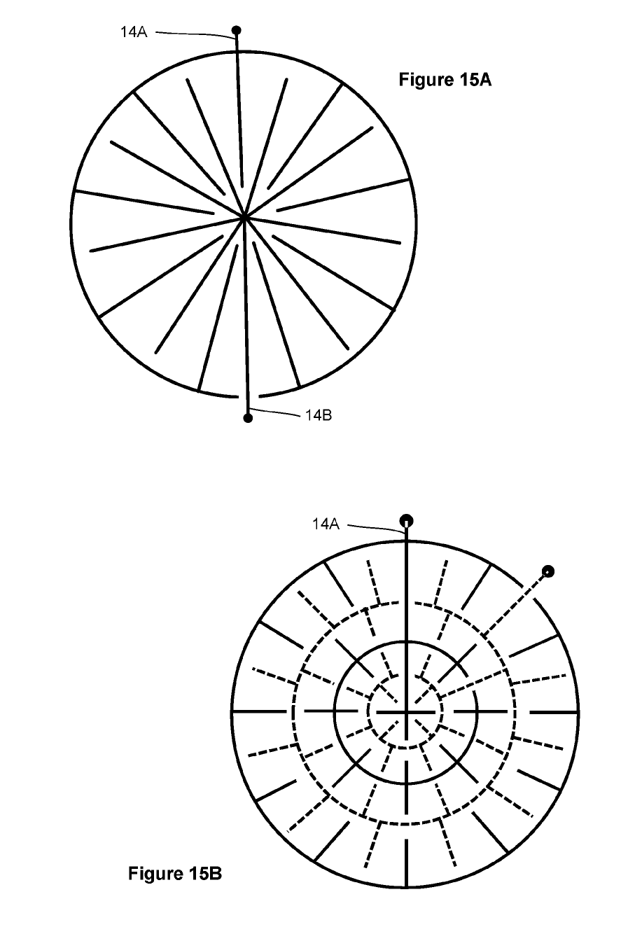

The device illustrated is highly schematic and not to scale showing in cross-section four electrode gaps g. In a specific example, each slit shaped gap between strip electrodes 14 can provide a controllable cylindrical lens element for beam divergence control. The arrangement of electrodes 14 can be linear (i.e. fingers, see FIG. 13), concentric rings/spiral (see FIGS. 14A and 14B with or without a complementary radial or star arrangement of electrodes, see FIGS. 15A and 15B) or any other suitable configuration. The number of electrode gaps over a beam control device aperture can vary according to the application. Different element gap shape apertures can provide beam shape control other than beam divergence control. Beam divergence control can be useful in a variety of applications including, but not limited to: ambient, set and architectural lighting.

When a drive signal having a voltage is applied across electrodes 14 and 16 in FIG. 1 the electric field (see the field lines illustrated on the rightmost cell) is stronger in the LC layer (space) volume adjacent and between the electrodes 14 and 16 than over the gaps between the electrodes 14. A layer of a highly resistive material (not shown) can be added near the electrodes 14 to help distribute the electric field over the gaps (between electrodes), however, when the aspect ratio of the gap g to liquid crystal layer thickness L is relatively small, then such a highly resistive material layer provides a diminished benefit.

A layer of nematic liquid crystal material 20 controls a single polarization component of light. As is known in the art, such LC layers can be stacked together so that the overall device can modulate both (linear) polarization components of a light beam propagating through the device. In the embodiment of FIG. 1, the liquid crystal material 20 is shown to have a ground state alignment almost parallel with the substrates such that in the ground state liquid crystal molecules would have a low pre-tilt angle from left to right. To modulate the orthogonal light polarization, another layer of nematic liquid crystal can be provided to have an alignment parallel with the substrate extending into or out of the page. For certainty, the use of nematic liquid crystal material is not intended to limit the invention thereto; other liquid crystal materials can be employed.

Furthermore, for beam control purposes, the strip electrode pattern shown in FIG. 1 can be used to cause beam shaping in one direction (for example in one azimuthal plane) and for one light polarization only. For beam shaping in two directions (in two azimuthal planes), multiple (additional) LC layers can be used with a pattern of control electrodes 14 that are orthogonal.

Similar to FIG. 1, FIG. 2 shows a beam control device having a single liquid crystal layer 20 that has, on one (top) substrate 12, independent electrodes 14A and 14B separated by gaps g to provide a control electric field between electrodes 14a and 14B that is spatially variable in the volume of liquid crystal material below each gap g. When a control signal having a voltage is applied across electrodes 14A and 14B in FIG. 2 (see the field lines illustrated on the two rightmost cells), the electric field follows a geometry oriented essentially parallel to the (separation) direction between the electrodes 14A and 14B at a midpoint of each gap g, while the orientation of the electric field lines turns to be essentially perpendicular to the (separation) direction between the electrodes 14A and 14B near (at) the edges of each gap g. The control electric field of the device geometry illustrated in FIG. 2 has a very different geometry than that of the control electric field of the device geometry illustrated in FIG. 1, however, the liquid crystal orientation under conditions of the applied control signal (voltage) can be similar (but not identical).

In FIG. 2, the aspect ratio (R) of the electrode spacing (g), or period between the electrodes 14A and 14B, and the thickness of the liquid crystal layer (L), R=g/L, can be, for example, between 0.7 and 4 (preferably about 2.5 for a microlens application) without using any weakly conductive material coating on or at the insulating substrate 12 on which the electrodes 14A and 14B are provided (located). For example, the electrode gap spacing g can be about 100 microns, while the LC layer thickness L can be about 50 microns for an aspect ratio of about 2. The width of the strip electrode 14A, 14B can be subtracted from the (step or) spacing g to obtain the aperture of an element. Surprisingly, the aspect ratio R has been found to play an important role in determining the desired electric field spatial variation as described above. The electrodes 14A and 14B are shown arranged on a LC cell inside side of the substrate 12, however, electrodes 14A and 14B can also be located on an outside side of the substrate 12. This latter arrangement may require a higher drive signal voltage, however, the electric field geometry can be better suited for modulating the electric field within the liquid crystal material volume for some applications.

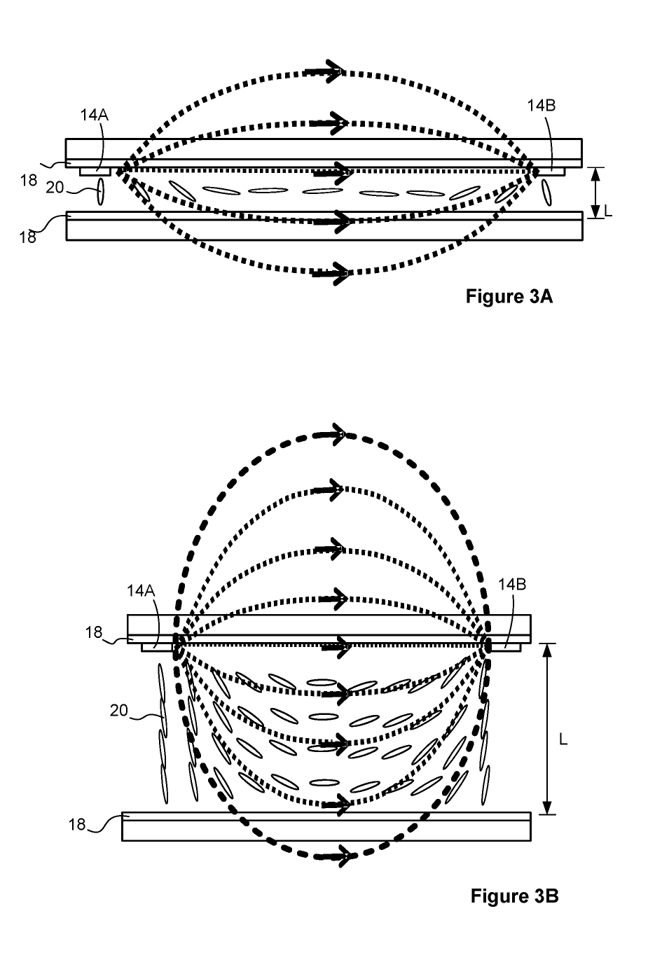

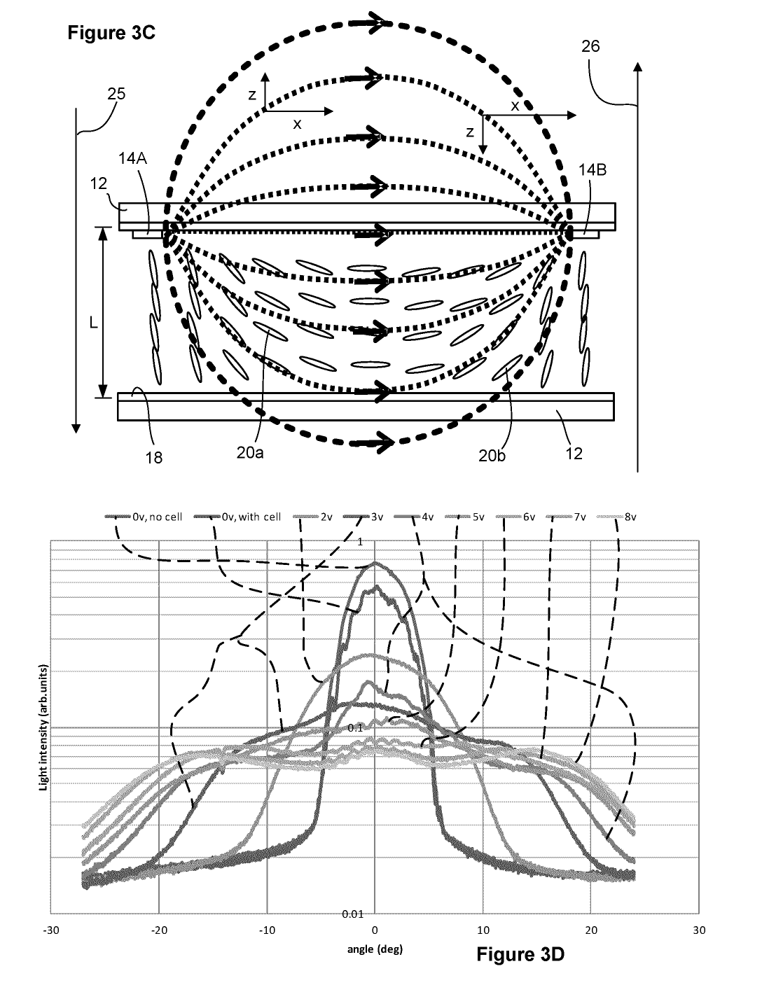

FIGS. 3A to 3C schematically illustrate in greater detail characteristics of the electric field generated from a single pair of parallel strip electrodes 14A and 14B similar to those of FIG. 2. FIG. 3A illustrates an aspect ratio R of about 10. The electric field lines in the cell are mostly parallel to the LC cell substrates except for fringe areas near the electrodes. This arrangement is known for use in displays where the liquid crystal needs to switch between two states, namely a ground state (e.g. twisted nematic or homeotropic) and a powered state in which the liquid crystal is aligned parallel to the substrates. The purpose for using such a control arrangement can be to provide a uniform reorientation of the liquid crystal material within the LC cell element between the electrodes 14A and 14B which is less suitable for beam shaping control applications such as beam broadening.

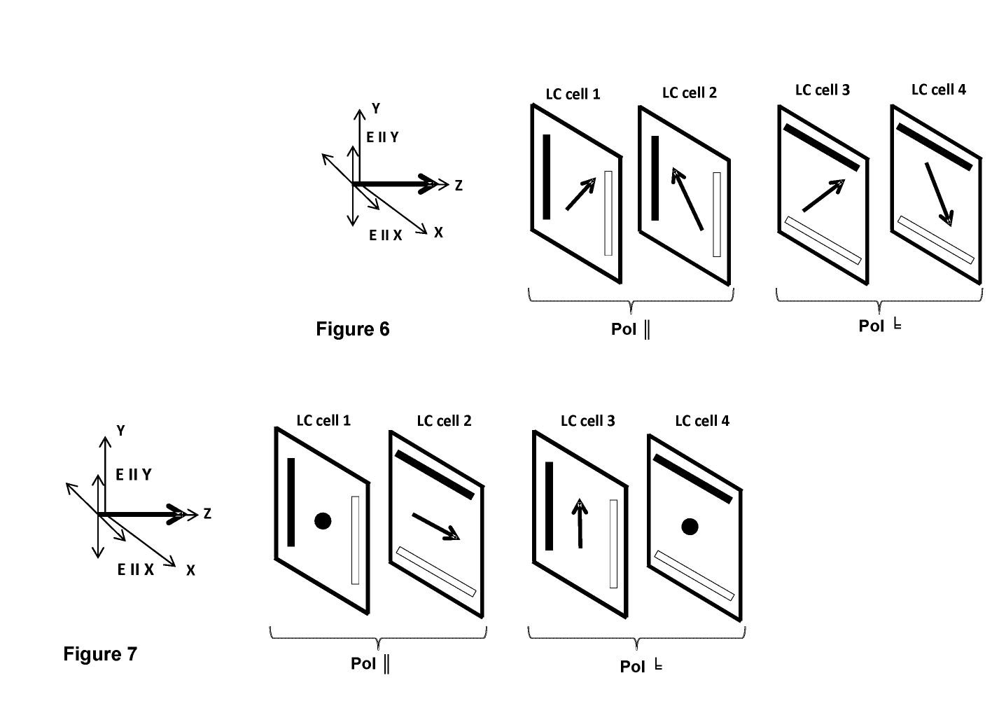

FIG. 3B schematically illustrates a LC cell element geometry in which the aspect ratio R is less than about 1. Such a small aspect ratio can for example be efficient for redirecting light from color pixels of a display so that chosen pixels become viewable from only a right eye or a left eye viewing angle for example in an autostereoscopic display. Various examples of such liquid crystal devices are described in US patent application publication 2010/0149444 to Hikmet et al. and in particular with reference to FIGS. 6A to 6D therein. The (initial/ground state) alignment of the liquid crystal material described in the Hikmet '444 reference is homeotropic. The intensity distribution as a function of viewing angle provides side-lobe peaks that can be suitable for autostereoscopic applications, however such a LC cell element geometry fails to provide (even) uniform intensity beam broadening suitable for a camera flash, architectural lighting and other illumination applications.

As will be appreciated from FIGS. 3A, 3B and 3C, the aspect ratio R has an influence (impact) on the spatial profile of the liquid crystal orientation within the LC cell, and an effective beam shaping optical device can be provided with a suitable aspect ratio R as illustrated in FIG. 3C, whereas optical devices illustrated in FIGS. 3A and 3B provide beam shaping that is not uniform. In accordance with the proposed solution, FIG. 3C illustrates a LC cell element geometry in which the aspect ratio R is greater than about 1 and less than about 4.5.

The experimental LC cell characterized in FIG. 3D has an electrode gap g of about 75 microns, electrode 14A, 14B width of about 15 microns and a liquid crystal layer thickness L of about 60 microns. This provides an aspect ratio of about 1.5. As shown in FIG. 3D, experimental results show that the intensity of a light beam propagating through a beam control device configured as illustrated in FIG. 3C, an (uncollimated/slightly divergent) incident beam having initially an angular distribution of +/−5 degrees (FWHM) about the normal can be broadened (further spread) to have substantially a uniform intensity (shown plotted on a log scale) with an angular distribution of about +/−20 degrees FWHM about the normal using a control signal voltage of about 5V to 8V. The beam is broadened from a beam having an angular distribution (divergence) of about +/−5 degrees FWHM to a FWHM range of +/−12 degrees to +/−25 degrees. By “substantially uniform intensity”, it can be understood that the beam's angular distribution is free of perceptible “hot spot(s)”, namely projected regions that appear particularly brighter than others. At higher control signal voltages, the intensity at 15 degrees FWHM increases to be a bit greater than for 8 FWHM degrees, however, the formation of pronounced side lobes is avoided.

In the embodiment illustrated in FIGS. 2 and 3C, the electric field has components that are “vertical” (“out of plane”), namely perpendicular to the substrate 12 at which the electrodes 14A and 14B are located, and “horizontal”, namely extending between the electrodes 14A, 14B parallel to the cell substrates 12 (in the electrode gaps).

When the liquid crystal material is oriented in its ground state by an alignment layer 18 defining a pretilt angle that provides initial (preferential) in-plane molecular orientation extending (in the direction) between the electrodes 14A and 14B (perpendicular to the electrode strips), an asymmetry is expressed (occurs in) the output broadened beam intensity due to the pretilt angle. The pretilt angle of the alignment layer 18 generates an asymmetric local orientation difference between the electric field and the desired spatial distribution of orientation of the liquid crystal in the LC cell. As illustrated in FIG. 3C, the left side orientation of liquid crystal at 20a is aligned with the electric field, while the right side orientation of the liquid crystal at 20b is likewise aligned in the opposed direction with the field, however with a planar alignment of the liquid crystal in the ground state, some asymmetric variation will occur.

The strip electrodes 14A and 14B can be sufficiently narrow enough so as to reduce the size of the boundary zone between adjacent cells. The overall device aperture having a LC cell illustrated in FIG. 3C can have many such (cells) control elements, whether arranged in strips, rings, spirals or other geometric patterns, for a small electrode gap g of each control element (cell) of about 30 microns to about 90 microns, and typically around 50 microns, about 20 control elements (cells) per linear millimeter of aperture can be provided.

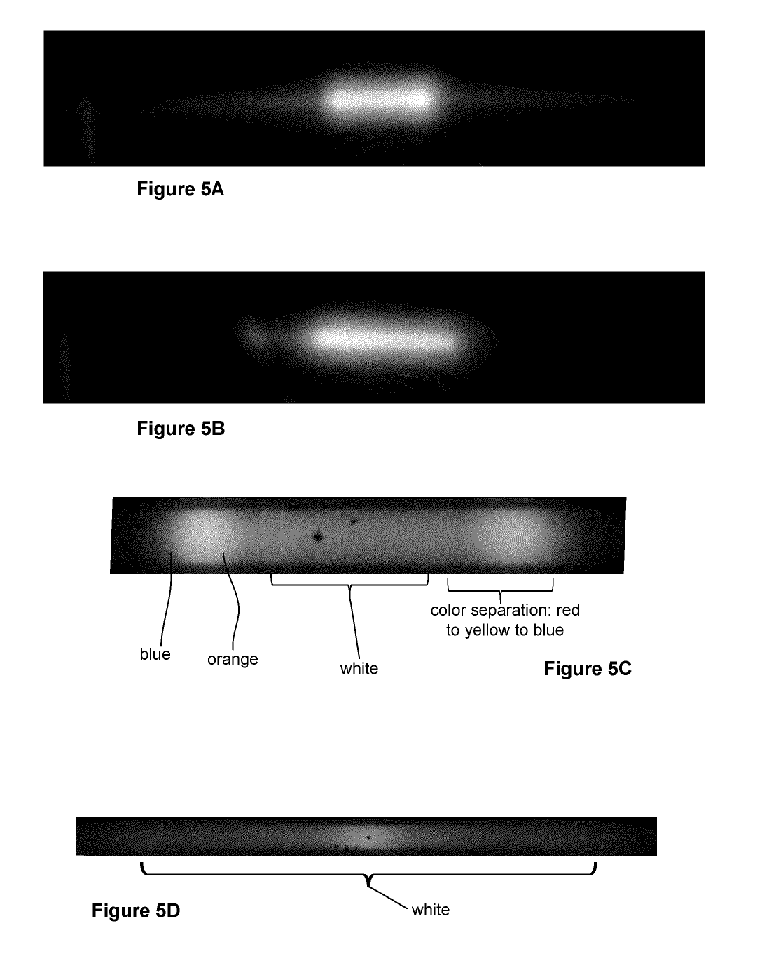

FIGS. 5A and 5B show projected images of the same incident beam broadened by a beam broadening device having a patterned electrode structure similarly to that illustrated in FIG. 2 with a large number of interdigitating (finger) strip electrodes 14A, 14B and therefore a large number of control elements, control elements which have a suitable aspect ratio R as illustrated in FIG. 3C. The projected beam intensity distributions shown in FIGS. 5A and 5B correspond to light beam propagation traversing the LC cell in direction 26 and 25 respectively (see FIG. 3C). As can be seen, Applicant has discovered that the incident beam is broadened significantly more when propagating in direction 25 than when propagating in direction 26. It has also been observed that when the liquid crystal orientation is of different in-plane orientation, such as twisted nematic and pi-cell, the same preferential effect for the propagation direction 25 over propagation direction 26 is present. Some of these discovered effects can be understood with reference to FIG. 3C wherein the electric field is not only variable with depth (L) within the LC cell volume but the electric field lines also have a differing curvature which also varies with depth within the LC cell volume. An incident beam of light propagating in direction 25 experiences first a strong electric field having electric field lines of low curvature and progressively experiences a weak electric field having electric field lines of high curvature. Conversely, an incident beam of light propagating in direction 26 experiences first a weak electric field having electric field lines of high curvature and progressively experiences a strong electric field having electric field lines of low curvature. With LC molecular axes being reoriented by electric field lines and local extraordinary ray refraction within the LC material being enhanced with depth of propagation, the graded index variation experienced by each ray can have a different influence depending on propagation direction. It is surprising that such property variations express large measurable output beam variations.

It has also been observed that for homeotropic liquid crystal orientation in the ground state, namely for high pretilt angles close to parallel to the normal, dynamic beam broadening can be improved for direction 26 over direction 25. It is surprising that such effects express large measurable variations.

The result of a liquid crystal ground state orientation being in a direction extending between the electrodes 14A and 14B can be an asymmetry of director reorientation profile and/or generate a disclination in response to the electric field. In addition, the chromatic dispersion of the created microlenses becomes rather large. These problems may produce a visible distortion in the transmitted light. For example, FIG. 5C demonstrates a colour separation effect that was produced using a multi-finger strip electrode arrangement as per FIG. 2 receiving a collimated incident light beam. As can be seen, the broadening is not centro-symmetric, the broadening angle is modest, there are bright spots at the edges and there is chromatic dispersion generating the visible color separation.

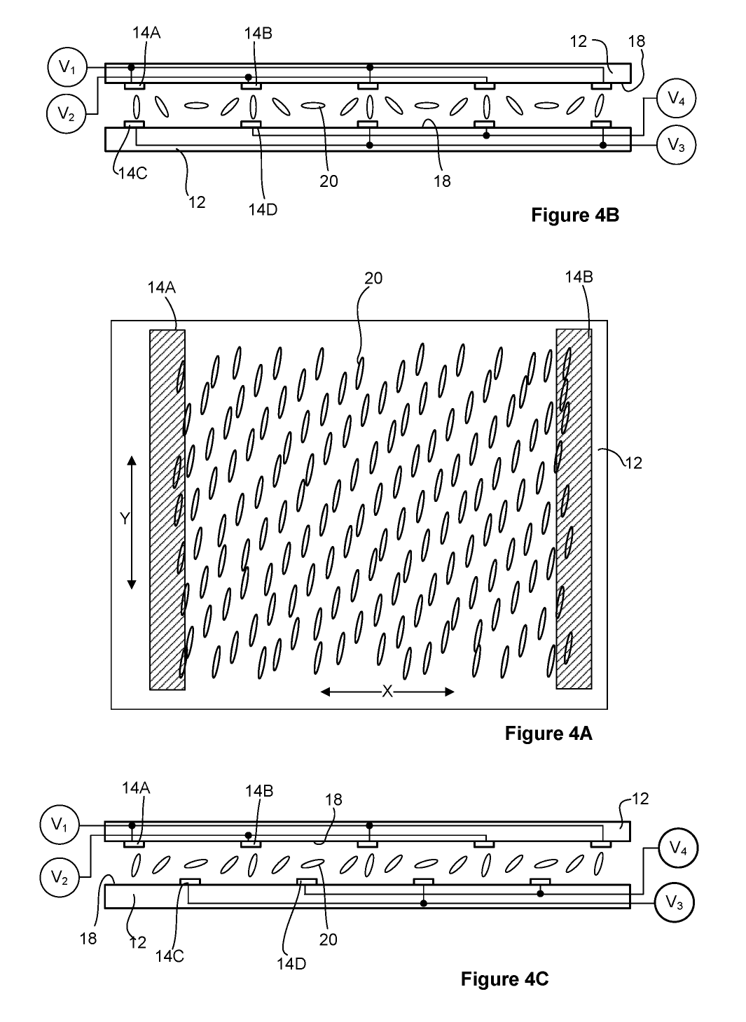

In FIG. 4A, schematically illustrates in plan view an alternate configuration in which the (in-plane) orientation of the alignment layer 18 is almost parallel of the strip electrodes 14A and 14B. In this configuration, the electric field component in the (horizontal) X direction would act on the LC molecules to turn them sideways against the (restorative orienting) action of the alignment layer 18. However, the (vertical) or Y direction component of the electric field acts on the liquid crystal molecules 20 with good symmetry across the gap (while the X, Y and Z axes are not illustrated in FIG. 4A, they are shown in FIGS. 6 and 7). This configuration provides good beam broadening symmetry, as illustrated in FIG. 5D. As shown, there is little or no chromatic dispersion and the intensity distribution is desirably broad and smooth (with good uniformity). The quality of the beam shaping in the embodiment of FIG. 5D can be achieved for the electrode configuration of FIG. 1 as well.

In accordance with another embodiment of the proposed solution illustrated in FIG. 4B, strip electrodes 14C and 14D are also provided and drive signal components are supplied to each of the electrodes 14A, 14B, 14C and 14D for device operation. Control of the respective voltages can allow for quick uniform change in orientation of the liquid crystal material 20 within the beam control elements (cells) by selection of control signal phases and/or voltages of the drive signal components V₁ to V₄. For example, when the electrodes 14A and 14C are driven at a common voltage, and electrodes 14B and 14D are likewise driven another common voltage that is 180 degrees out of phase with the electrodes 14A and 14C, then the liquid crystal 20 is subjected to an electric field that is essentially parallel to the substrates 12, particularly in the middle of the cell (far from the zone between opposed electrodes), and the liquid crystal material 20 can be oriented quickly to be close to a ground state when the (ground state) liquid crystal orientation extends in the direction between electrodes 14A and 14B.

In the case of homeotropic ground state liquid crystal alignment, a quick restoration to the ground state can be achieved by applying a same control signal voltage to all electrodes on one substrate 12 and a same control signal voltage of opposite polarity to all electrodes on the other substrate 12. The addition of intermediate grounded electrode lanes (between and parallel to electrodes 14) can be beneficial at least in some applications.

Furthermore, the presence of additional linear electrodes on the surface of opposed substrate in the layered geometry illustrated in FIG. 4B, the thickness L of the liquid crystal layer may be chosen to be larger, wherein the extra thickness is used more efficiently compared to the case where only one substrate 12 has electrodes for example as illustrated in FIG. 2. This will allow obtaining larger beam broadening angles by increasing the interaction time of the light beam propagating though the liquid crystal thickness without an increase in control signal voltage.

Additionally, the beam control element described in FIG. 4B will provide an output beam having improved symmetry and without a noticeable difference related to the propagation direction of the light beam through the beam shaping device.

In accordance with specific implementations of the embodiment of the proposed solution illustrated in FIG. 4B, various liquid crystal alignments may be applied to the element described in FIG. 4B, including homeotropic, planar (0°, 45°, 90°, or other). The particular case of 90° in-plane alignment (when the liquid crystal alignment is perpendicular to electrode strips 14) can be of interest for various applications. For example, rubbing the alignment layer may be done from left to right on both internal surfaces of top and bottom substrates 12. Accordingly, the liquid crystal pretilt angle will be positive on one (substrate) LC cell wall surface and negative on the other opposed (substrate) LC cell wall surface. In this case, the activation of electrodes 14 can generate relatively symmetric broadened pattern of light.

In accordance with another embodiment of the proposed solution, additional beam control options (such as broadening and steering) may be achieved if a predetermined shift is provided in one group of electrodes 14 with respect to the other group, as illustrated in the FIG. 4C. Such a beam control device can generate tilted (asymmetric) fields and also steer light direction.

Implementations of the proposed solution for shaping light of different polarizations, pairs (orthogonally) orientated layers of liquid crystal can be controlled by electric fields having similar spatial profiles. Thus a beam control device can be configured to control unpolarized light by employing two layers of orthogonally aligned liquid crystal. Alternatively, two layers of the same alignment can be arranged with a 90-degree polarization rotation device provided between the two layers. A patterned electrode array as described with reference to FIGS. 1 and 2 can be used to broaden an incident beam in one direction or azimuthal plane. To broaden the beam in two directions (along two azimuthal planes), additional LC layer pairs can be used.

Orienting the liquid crystal material in the manner shown in FIG. 4A provides a reduction in color separation for one light polarization, but not for the other light polarization (without employing a polarization rotation device). Thus the problem illustrated in FIG. 5C cannot be simply resolved in the manner shown in FIG. 4A for both polarizations.

In accordance with an embodiment of the proposed solution the in-plane alignment orientation of the liquid crystal can be provided at roughly a 45 degree angle to the direction of the electrodes 14, such a geometry allows the same compromise to be employed for each of the two light (linear) polarization components. Such a layered geometry is schematically illustrated in FIG. 6 for beam control for two directions (azimuthal planes) and for both polarizations. While the chromatic aberration or color separation reduction is not as good as in the embodiment illustrated in FIG. 4A, for the embodiment illustrated in FIG. 6, when the direction of alignment is at 45 degrees with respect to the direction of the strip electrodes 14A and 14B, the problem of color separation shown in FIG. 5C is greatly reduced.

In accordance with a further embodiment the proposed solution, schematically illustrated in FIG. 7, one of the LC layers can employ homeotropic liquid crystal alignment that consists of orienting liquid crystal molecules to be perpendicular to the substrate in the ground state.

As described above, it will be appreciated that when arranging LC cells, beam shaping performance improvements are provided by placing the patterned electrode side facing the light source for embodiments employing in-plane (planar) LC ground state alignment, while for embodiments employing homeotropic, beam broadening performance improvements are obtained by placing the opposed substrate facing the light source.

When mixing cells of both planar and homeotropic alignments, special care can be exercised to provide the appropriate layered geometry for best performance. In accordance with an implementation such mixed ground state alignment embodiment of the proposed solution, two liquid crystal layers employing homeotropic ground state alignment orientation, with orthogonally oriented strip electrodes can be used for broaden or steering a light beam in two directions (along two azimuthal planes). In accordance with one example implementation, such a pair of LC layers can be configured to be separated by a substrate that has a low anchoring energy on both of its surfaces to decouple the molecular deformations in each of the neighbouring LC cells.

When arranging liquid crystal cells stacked as illustrated in FIGS. 6 and 7, it has been found that the electric field of one LC cell in the stack can cause undesirable reorientation effects on the liquid crystal material of neighboring LC cells. In such cases, sufficient spacing between the liquid crystal layers is provided to avoid undesirable effects. In some applications, such additional spacing may be reduced by depositing a transparent conductive layer on intermediary outer substrate side(s) between LC cells to shield one LC layer from the control electric field of the neighboring LC cell. The transparent conductive layer may be left electrically floating or may be grounded. While the combined thickness of the device has a smaller factors, depending on the application additional layers may be needed to counter or address effects introduced by such transparent conductive layer, for example to reduce undesirable internal reflections.

When arranging orthogonal arrays of electrodes or patterned electrodes, as for example for the embodiment illustrated in FIG. 7, it is possible to arrange electrodes within a substrate separating neighboring liquid crystal layers. For example, a relatively thick substrate (e.g., 500 micrometer) can be provided with an ITO coating, and the electrode strips 14 (lines) can be etched out from the ITO coating. Then two such elements can be provided with one rotated at 90 degrees with respect to the other and glued together with an optical adhesive which also acts as an electrical isolator (e.g. 3-5 micrometers thick). The thick element obtained (about 1005 micrometer thick) can for example be chemically slimmed down to 100, or even better to 50 micrometer, for example. This composite substrate can be used as an intermediate substrate between two liquid crystal layers having crossed directors. Such a substrate provides an overall fabrication cost advantage providing similar operation in both (adjacent) LC layers. However such a composite substrate can have a drawback of employing slightly higher control signal voltages compared to implementations in which the electrodes 14 are formed inside between substrates sandwiching each LC layer.

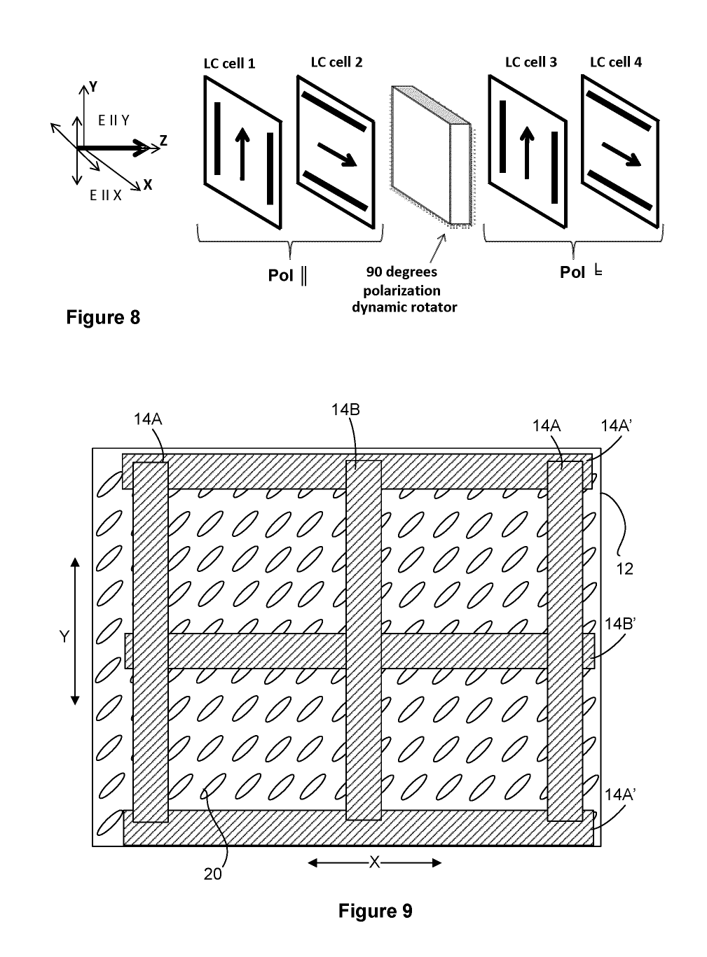

FIG. 8 illustrates a variant embodiment which expands on layer geometries illustrated in FIGS. 6 and 7 in which LC cells 1 and 2 are the same as LC cells 3 and 4, however, a 90 degree polarization rotator is added between cells 2 and 3 as illustrated to provide beam control of orthogonal light polarization components.

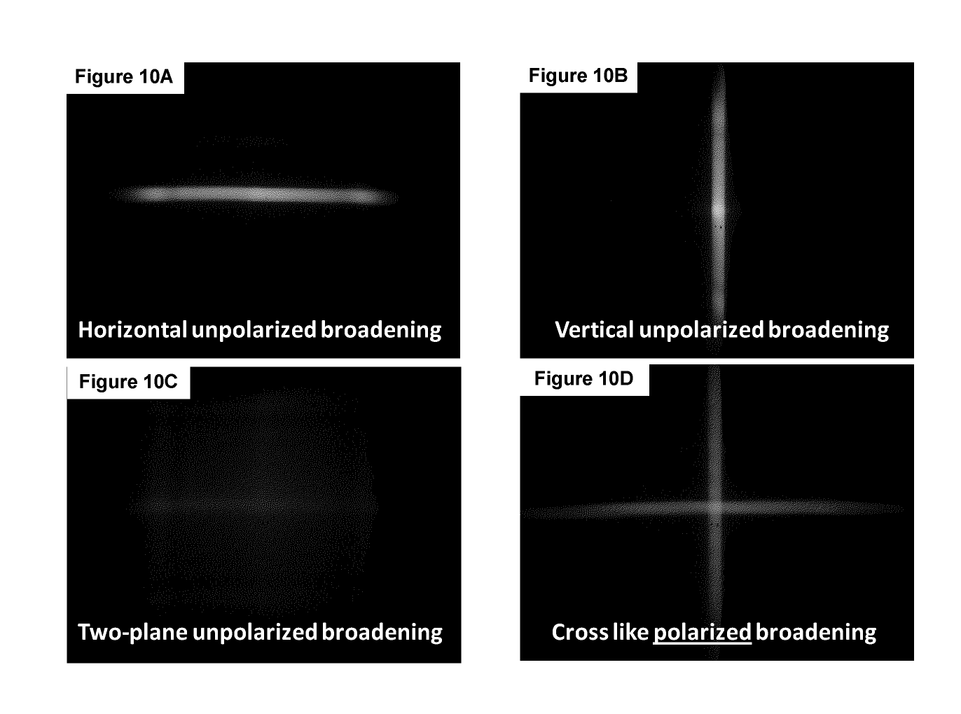

A similar alternative can be provided based on the same assembly of LC cells and electrodes however employing homeotropic alignment in all LC cells (except in the polarization rotator). When the rotator is a passive element, the output beam can express in four different projection states: (1) the source beam traverses the stack unmodulated, for example projecting a spot pattern when both sets of LC cells are not powered (not shown in FIGS. 10A to 10D); (2) a horizontal line as illustrated in FIG. 10A when only one pair of LC cells is powered to provide beam broadening along one azimuthal plane; (3) a vertical line as illustrated in FIG. 10B when the other pair of LC cells is powered to provide beam broadening along the other azimuthal plane; and (4) a two-direction broadening as shown in FIG. 10C, 10D when all cells are powered to provide beam broadening in two azimuthal planes. The order of the LC cells 1, 2 and 3, 4 can be interchanged.

In accordance with this embodiment of the proposed solution, by employing a dynamically switchable polarization rotation element, for example a twisted nematic liquid crystal cell, the light pattern can be changed from, for example, a substantially uniform two-plane broadening as illustrated in FIG. 10C into a cross-like intensity distribution as shown in FIG. 10D as the 90 degree polarization rotation is removed. Other liquid crystal layer (orientation) ground state alignment configurations can also be used in this approach, such as those described above, for example using an alignment orientation that is 45 degrees with respect to the electrodes 14, or alternatively using homeotropic alignment.

FIG. 9 illustrates a variant embodiment in which the nematic liquid crystal is aligned in the ground state using rubbed surfaces at a 45 degree angle to the electrodes 14A and 14B. In this embodiment, as illustrated, electrode strips 14A′ and 14B′ can also be arranged orthogonally to electrode strips 14A and 14B, and the direction of rubbing is also at 45 degrees to electrode strips 14A′ and 14B′. Electrode strips 14A′ and 14B′ are electrically insulated using an insulation layer from electrode strips 14A and 14B. This arrangement allows for beam shaping in the X direction and/or in the Y direction. Without any such insulation, a hole-patterned electrode mask could be used for combined X+Y direction beam shaping when an opposed electrode is provided, as for example in FIG. 1. The device illustrated in FIG. 9 has a single layer of liquid crystal material and modulates a single (linear) polarization of light in two perpendicular azimuthal planes. An additional, orthogonally oriented layer of liquid crystal is required to modulate both light polarization components.

The orthogonal electrode configuration of FIG. 9 can provide independent directional control over beam shaping, while simplifying manufacturing. A double lithography process can be used to create (consecutively) crossed pairs of electrodes on the same substrate (separated by an isolation layer), as schematically shown in FIG. 9. This can avoid alignment problems otherwise occurring during assembly of devices when the control electrodes for each beam control direction are provided on their own substrate.

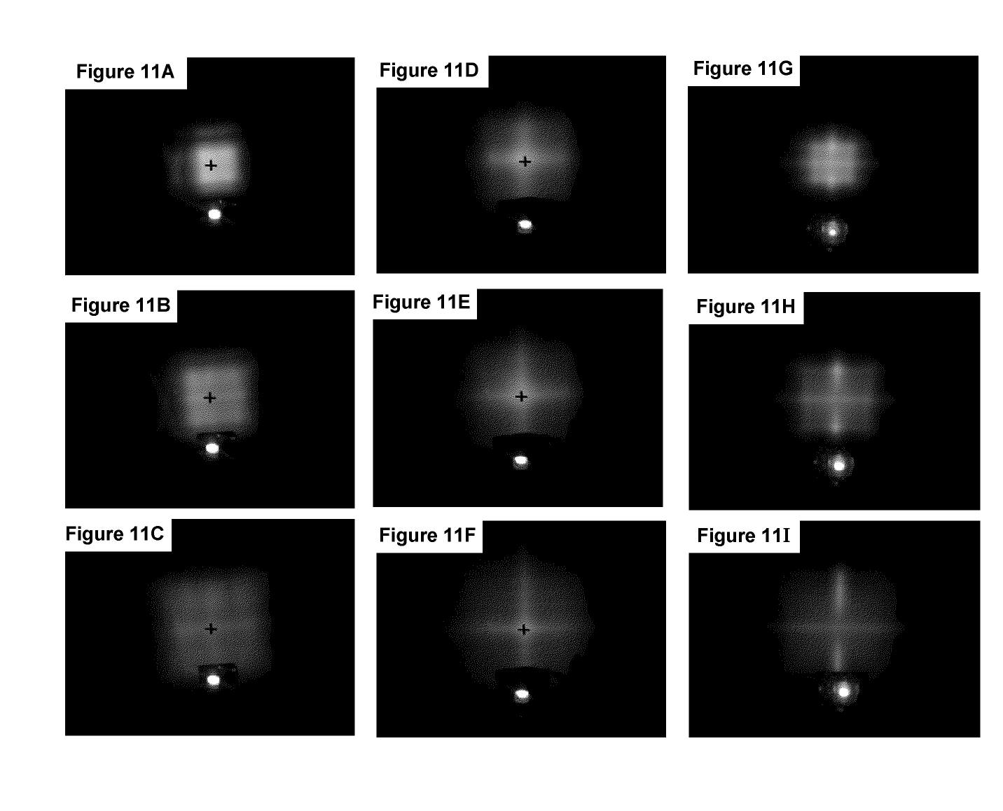

Experimental results using a four LC cell device as schematically illustrated in FIG. 6 (having patterned electrodes of many parallel fingers 14A, 14B as described with reference to FIGS. 2 and 3C) are shown for different voltages and liquid crystal ground state orientations in FIGS. 11A through 11I. The electrode strip width was 15 microns, the gap g between electrodes was 75 microns, the thickness of the liquid crystal layer L was 60 microns, and the liquid crystal material had an optical anisotropy of Δn of about 0.2. No opposed ground electrode was used in the experimental device, employing electric fields schematically represented in FIG. 3C.

FIGS. 11A, 11B and 11C show projected beam results at 4V, 5V and 7V respectively when the liquid crystal ground state orientation employed is as illustrated in FIG. 6. As can be seen, beam broadening in this experimental setup became quite uniform (even) and well distributed at 7V, whereas for lower control signal voltages, the amount of beam broadening was reduced. The central axis is marked with a cross throughout the images. Observed beam broadening was not symmetrical with respect to the optical axis due to the 45 degree ground state in-plane orientation angle. It has been found that this lack of symmetry is reduced for smaller aspect ratios R that are still suitable for beam control, as discussed above with reference to FIGS. 3A to 3C.

FIGS. 11D, 11E and 11F show projected beam results at 4V, 5V and 7V respectively when the liquid crystal ground state orientation employed is as illustrated in FIG. 8. It was observed that was that this device configuration provided greater beam broadening and reduced color separation at 4V than for the 45 degrees in-plane alignment orientation sample of FIG. 6, however, a mild cross-like hot spot remained observable as the control signal voltage was increased beyond 5V and up to 7V. Surprisingly, the projected beam symmetry with respect to the central axis was good.

FIGS. 11G, 11H and 11I show projected beam results at 4V, 5V and 7V respectively when the liquid crystal ground state orientation was homeotropic, namely perpendicular to the LC cell substrates. Such liquid crystal ground state alignment was used in the Hikmet '444 reference. As the light beam was broadened, see for example FIG. 11H by supplying a control signal at 5V, significant hot spots were prominent, coming from the “lobes” in the beam shaping performance. Undesirably, the presence of hot spots was also found at 7V. The symmetry with respect to the central axis was good.

When only one or more of a plurality of LC layers uses a homeotropic ground state alignment, as is the embodiment illustrated in FIG. 7 where cells 1 and 4 have homeotropic alignment, the presence of hot spots as illustrated in FIGS. 11G to 11I is diminished and not as pronounced. The order (or the sequence) of the LC layers can be changed as desired and/or to suit a particular application. The homeotropic layers have less asymmetry (leading to chromatic dispersion or color separation) than liquid crystal layer employing ground state in-plane alignment parallel to the substrates 12 oriented along the direction extending between the strip electrodes 14, and therefore the combination produces a beam control device that has less chromatic dispersion or color separation overall.

From these experimental results, the smoothest or most uniform (even) beam broadening was provided using non-homeotropic alignment, and in particular, liquid crystal material aligned in a ground state at 45 degrees with respect to the direction of the strip electrodes 14.

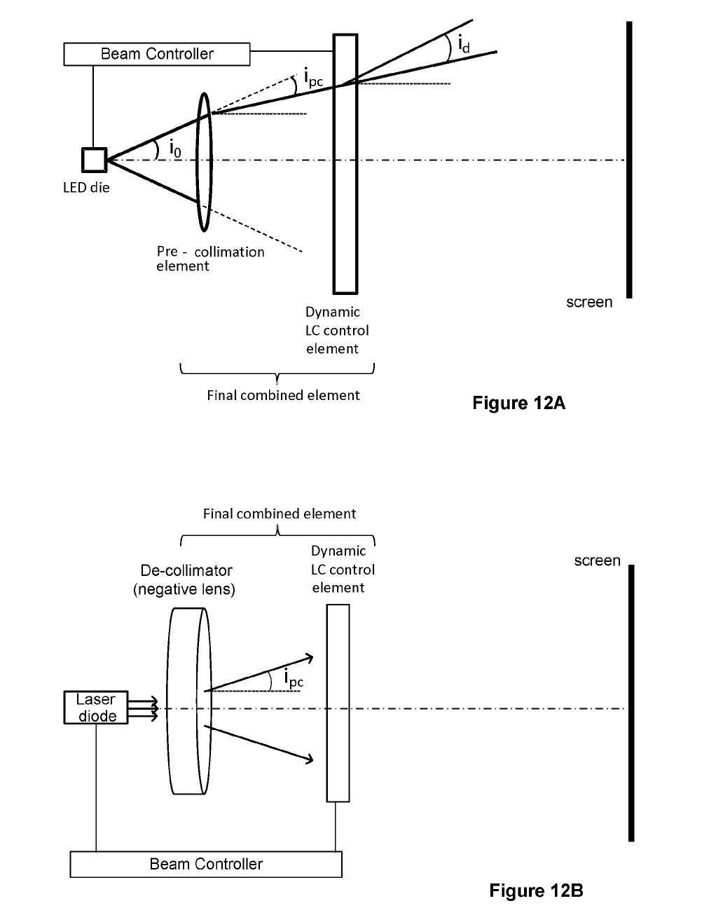

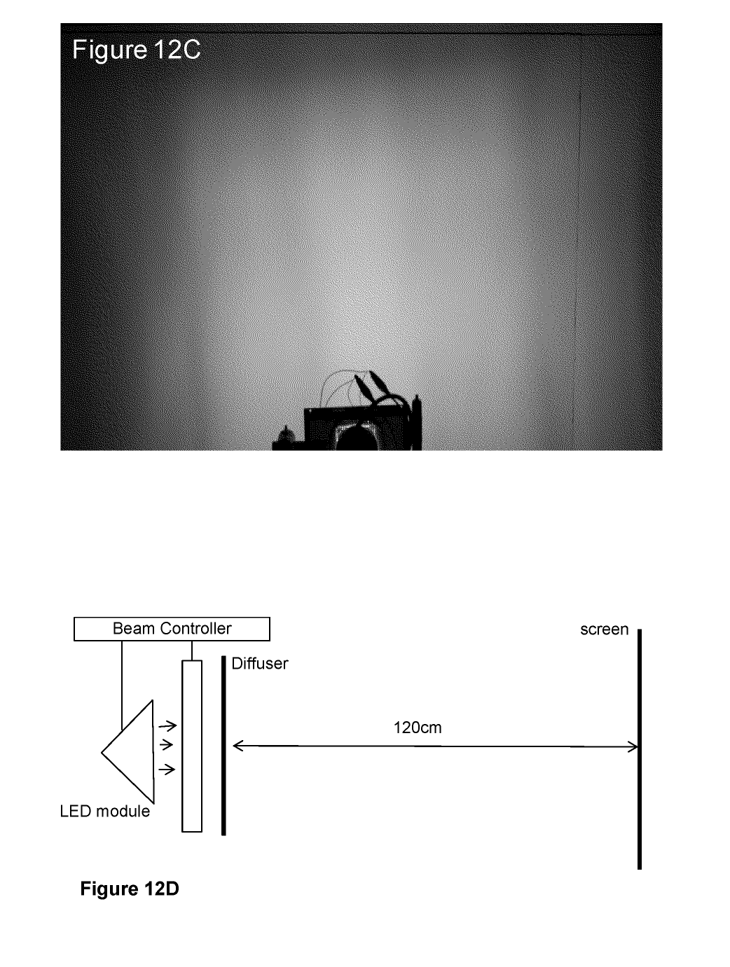

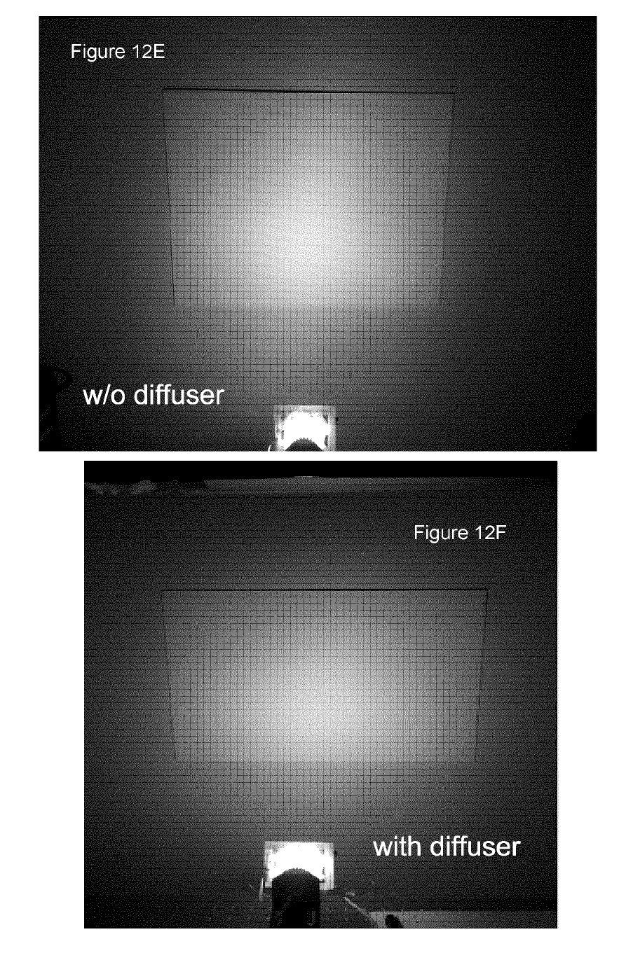

Liquid crystal based dynamic light beam broadening devices are known in the art. However, known devices have limitations. If the parameters of the LC element are set in a way to introduce only an additional broadening of the original source beam, for example having an original divergence of i₀ as illustrated in FIG. 12, then, from energetic, cost and esthetic points of view, the LC element should not be used if the i₀ is very large (say >±25°). This sets a top limit of acceptable initial divergence of the original light source beam.

In contrast, if the value of i₀ is very low (say about 0° for a laser beam or a laser diode beam) and the original light source has a relatively large/wide spectral content (such as a “quasi white” light source, say with >30 nm of spectral width), then there is another important problem related to undesired color separation in beam broadening, and to a lesser extent, in the case of beam steering (the traditional elements will generate rainbow-like color separation).

The light beam broadening solution proposed employs source beam conditioning such as de-collimation, as illustrated in FIG. 12A, or pre-collimation, as illustrated in and 12B, of a light source beam (i_{pc}) in a way to provide observable (visible) additional dynamic beam broadening within a broadening range (i_{d}) preferably with minimal color separation.

The color separation is very visible, and undesired, in the case of dynamic broadening of a wide spectrum (white) light source having a small original angular divergence (say about 0° from a laser or a LED diode). Color separation can be minimized in accordance with the proposed solution if an additional optical element 30 is employed for example to increase, de-collimate, or decrease, collimate the divergence the source beam slightly, but not too much, for example preferably to about, ±5° (while using the same light source and the same LC device to broaden the light beam). Alternatively, the original source beam may be slightly conditioned by increasing divergence or convergence before the source beam falls incident and enters into the LC beam control device for further dynamic broadening in a dynamic range.

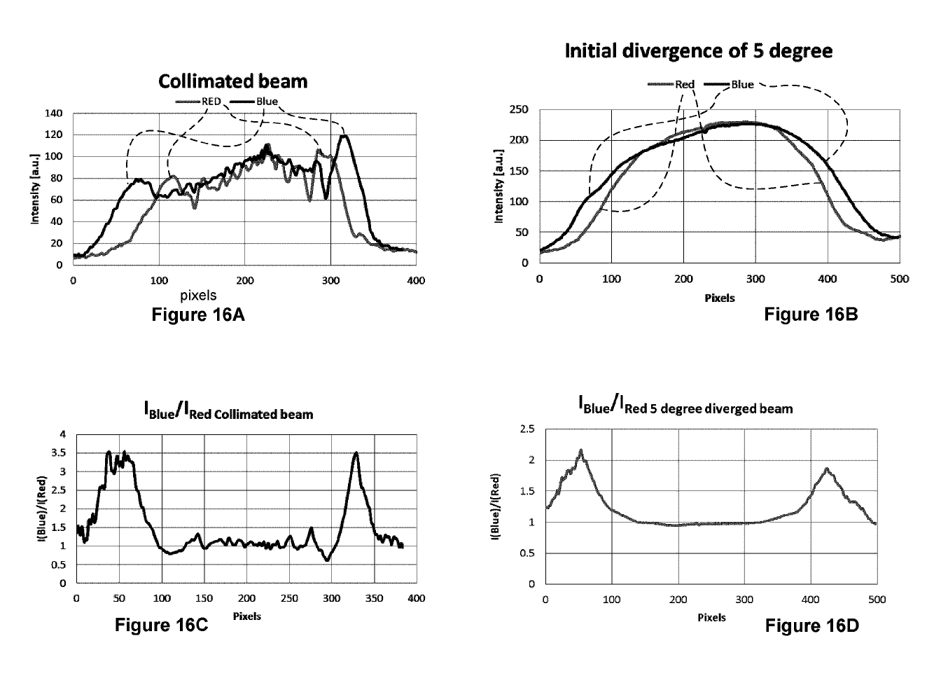

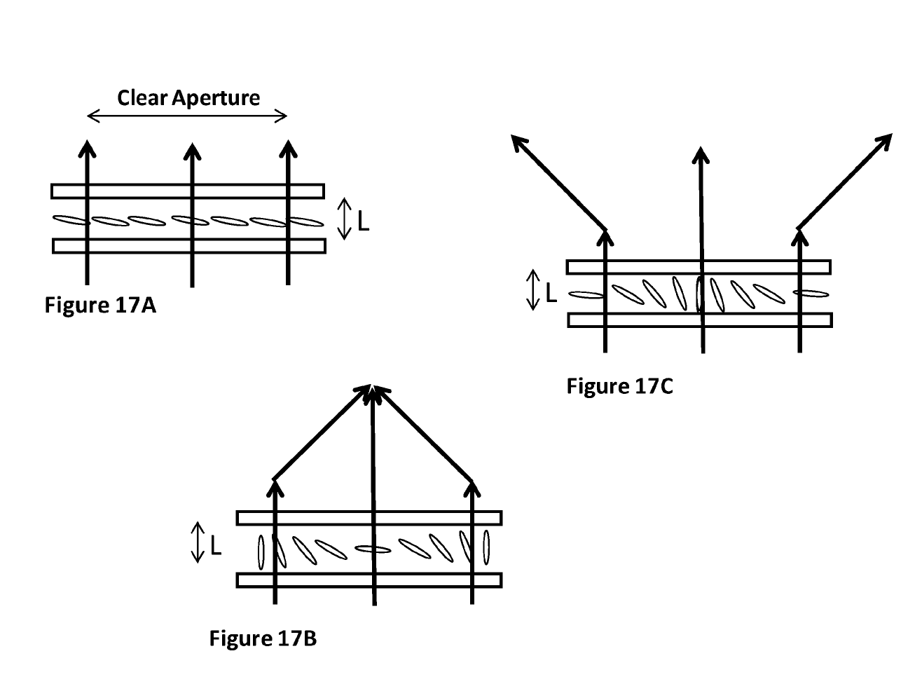

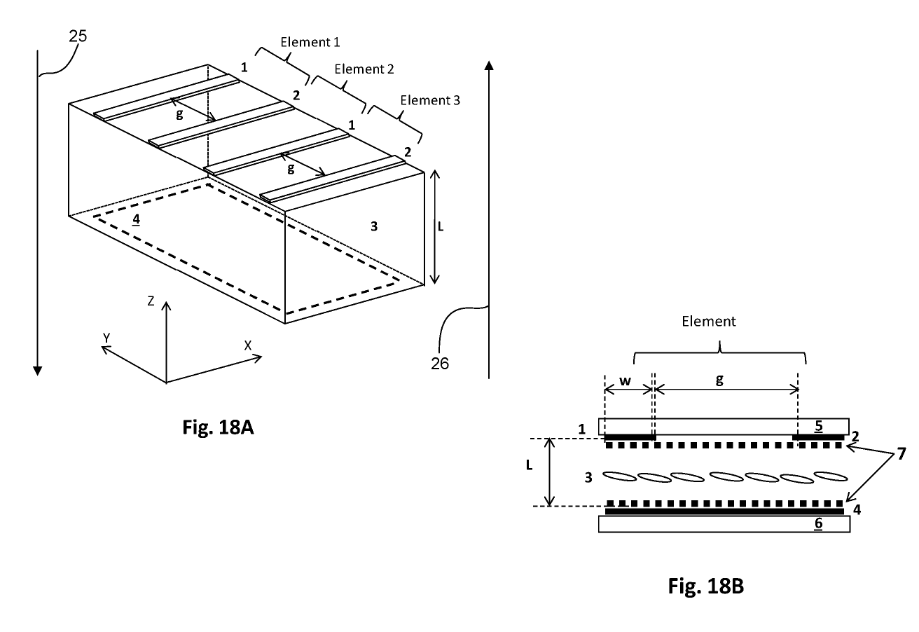

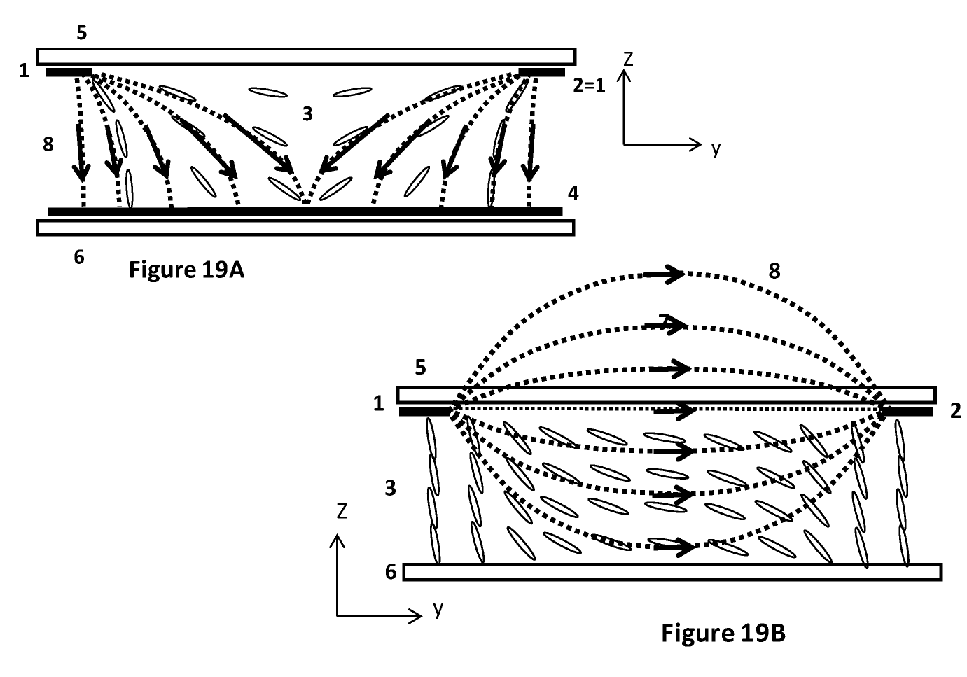

The effect of beam pre-conditioning can be seen in the experimental results shown in FIGS. 12C and 16A to 16D. When a collimated beam is passed through a beam broadening device like the one illustrated in FIG. 6, FIG. 16A illustrates a cross-section through a broadened projection of the collimated beam which expresses more blue than red at the sides of the projected beam which would be apparent as color separation. Surprisingly, when a ±5 degree FWHM divergent source beam is passed through the same device, the output beam is a bit wider (see the broadened beam width expressed in the number of pixels as shown in the plot of FIG. 16B compared to the plot shown in FIG. 16A) and the blue to red imbalance is much less perceptible. The blue to red ratio is shown in FIG. 16C for the collimated beam, and in FIG. 16D for the ±5 degree FWHM divergent beam. As shown, the side edges for the collimated beam have a ratio of blue to red intensity that surpasses 3, while for the ±5 degree FWHM divergent beam, the ratio of blue to red intensity is about 1.7. This is significant and substantial reduction of the color separation (almost a reduction in half).

As illustrated in FIGS. 12A and 12B, a beam controller is provided to generate beam control signals. For example, the light source, such as an LED die, can be controlled in intensity and/or in color using the beam controller. Also, the dynamic liquid crystal beam control element can be controlled using the beam controller, namely the electrodes 14A and 14B (or any of the electrode arrangements described above) can be controlled using the beam controller circuit via corresponding drive control signal(s). The beam controller can comprise dedicated circuitry or it can comprise configurable circuitry (e.g. FPGA), or it can be implemented using program code running on a suitable platform, for example a CPU or DSP based system.

In embodiments employing a primary optics to “prepare” (collimate or de-collimate) the incident light source beam of an LED source before it enters into the beam shaping control device, a strictly collimated LED beam after passing through the beam broadening device illustrated in FIG. 12A, the projected light beam expresses intensity modulation non uniformities (ripples, including color separation) as illustrated in FIG. 12C having non-uniformities which are indeed noticeably reduced with the slightly increased original divergence. In a particular LED source application having an initial large, ≥±10 degrees FWHM, of divergence, a simple diffuser can be employed in accordance with an embodiment of the proposed solution as a post-conditioning element as illustrated in FIG. 12D to obtain similar results to pre-conditioning a collimated source by providing de-collimation. For example it has been discovered that a diffuser which adds about 2.5 degrees FWHM of diffusion to the broadened beam output (having small intensity ripples and small color separation as illustrated in FIG. 12C) provides good post conditioning in terms of aberration reduction. In this configuration the intensity and color non-uniformities are significantly reduced (see FIGS. 12E and 12F) for example when employing an LED light source with 15 deg of original divergence (measured at FWHM), driving electrodes with control signals having −20V RMS amplitude and employing a simple LC cell geometry having homeotropic alignment with cross oriented electrode strips (fingers) on opposed surfaces of the LC cell. Such output beam quality can be sufficient for applications which can sacrifice 2.5 degrees FWHM of dynamic beam broadening range. In contrast, ripples remain if the diffuser is placed between the LED source and beam broadening device.

Thus, if the original divergence of the source (LED) module is ±10 degrees FWHM (typical spot light source), then a lens or even a diffuser may be used to increase divergence up to ±20 degrees FWHM. Then, the proposed beam broadening devices proposed herein can controlled to gradually change beam divergence from about ±20 to about ±40 degrees. This can reduces the dynamic range of the beam broadening device (low contrast) and in some applications it may be desirable to have a dynamic rage changing from about ±10 degrees to about ±40 degrees (increase contrast).

In accordance with an embodiment of the proposed solution, a primary dynamic diffuser is employed instead as the preconditioning element in FIGS. 12A and 12B. In its simplest form, such a dynamic diffuser can include a polymer dispersed liquid crystal device or another type of dynamic broadening device. It has been found that many dynamic diffusers maintain the angular divergence (opening limited, fixed) and change only the ratio of transmitted and scattered light, which can be undesirable.

In alternate embodiment, it has been discovered that ripples disappear when one of the half-polarization LC cells in a two LC cell full-polarization beam broadening device is twisted by more than 2-3 degree with respect to the other LC cell during the full beam broadening device assembly. Such rotation angle can be in the order of ±5 degrees FWHM and can provide a useful intensity ripple reduction.

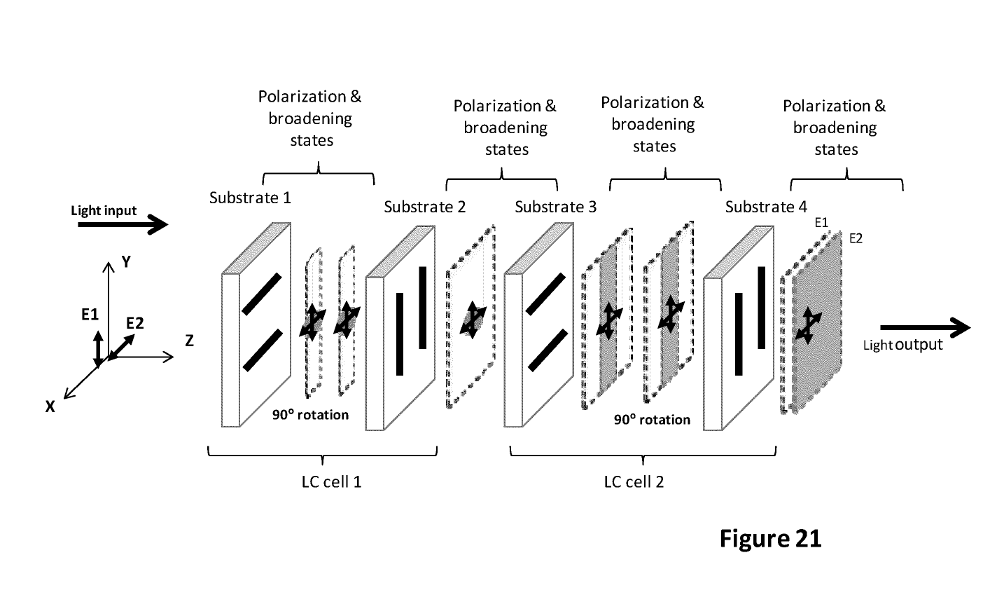

In accordance with an embodiment of the proposed solution illustrated in FIG. 12G illustrates a polarization independent two (azimuthal) plane beam broadening device employing two (sequential) beam broadening devices, preferably similar to one another but not necessarily so, such that the first orthogonal polarization directions affected by the first beam broadening device are rotated at certain angle, for example at about 45 degrees, to the second orthogonal polarization directions affected by the subsequent second beam broadening device. Details of each pair beam control devices as illustrated in FIG. 12G where a first pair thereof is twisted in respect to another pair by 45 degree around the Z axis are provided hereinbelow with respect to FIG. 21.

In the embodiment of the proposed solution illustrated in FIG. 13, there is shown an electrode array having strip electrodes 14A and 14B. The electrode spacing g is 50 microns in the middle of the 6 mm device aperture and 100 microns at the outer sides. In the example illustrated, the gap g increases (can also decreases) by 5 microns from one gap to the next. Small gaps provide a higher beam shaping or beam steering ability or power, and larger gaps provide smaller power. Such variation of electrode gap g may be linear or non-linear. An effect of the variation, or chirp, can be to eliminate or reduce color separation and hot spot formation in the (transmitted) projected light beam. This is because different portions of the overall optical device will redirect the same wavelength (i.e. color) of light in different directions.

For example, a beam can have symmetry with respect to an optical axis. In such as case, a centro-symetric arrangement of strip electrodes can be provided as concentric rings 14A and 14B as shown schematically in FIG. 14A. The spacing g of the rings can be closer near the central optical axis and farther apart from center near the outermost ring (or device aperture edge) to provide a more uniform (even) beam spread. The spacing g can also be configured to take into consideration a beam intensity profile for example to provide more elements where the intensity is greater. This type of electrode (concentric rings) may be used along with a star-shaped inter-digitated electrode structure on the opposed substrate of the cell, as shown in FIG. 15A or 15B. In some implementations conductive electrode traces interconnecting the concentric rings can induce undesirable effects in the projected beam, as illustrated in FIG. 14B the conductive electrode traces interconnecting the concentric rings can be provided at different, preferably random, angle about the normal.

It will be appreciated that FIGS. 13 and 14 merely illustrate schematically strip electrode patterns, and that such patterns can be applied to a variety of liquid crystal cell designs, including those described herein. In the case of concentric rings, beam shaping or beam steering is done in the one radial direction with respect to the optical axis, and thus a typical beam control device geometry can employ two layers of liquid crystal, one for each light polarization. The spatial chirp may also be applied in circular or star shaped electrode implementations. A particular version of star electrodes, for example illustrated in FIG. 15B, may contain additional branches to provide various gap g values, including equidistant implementations.

Since the direction of light polarization is determined by the electrode layout when the liquid crystal has homeotropic alignment, homeotropic alignment is less desirable for use with concentric ring electrodes for beam control devices that are to act on both polarizations of light. However, employing a 90 degree rotator placed between two homeotropicly ground state aligned LC cells, each LC cell having substantially identical concentric ring elements with all-homeotropic alignment can provide beam control for unpolarized light. It will be appreciated that this embodiment provides a couple of advantages: 1) full polarization independent operation for 2D beam broadening can consist of only two LC cells instead of four; and 2) the hot spots/lines may be reduced (eliminated) especially when using a labyrinth concentric design of strip electrodes (see FIG. 14B) with various gap g values.

Put another way, in a variant embodiment, FIG. 14B shows how the bridge connections between the concentric rings in FIG. 14A can be staggered (about the optical axis) around the beam control device aperture so as to reduce the appearance of artifacts, as preferably random staggering improves symmetry about the optical axis. FIG. 15A shows a centro-symmetric radial configuration of electrodes that are orthogonal to the concentric rings of FIGS. 14A, 14B. The electrode configuration of FIG. 15A can be provided on a common substrate as a concentric electrode arrangement with separation by an insulating layer (similar to the embodiment illustrated in FIG. 9), which can be added on the opposed substrate of the same LC cell, or it can be associated with a separate liquid crystal cell. FIG. 15B is a schematic plan view of a centro-symmetric array of concentric and orthogonal radial of electrodes 14A (solid lines) and 14B (dashed lines) with essentially uniform electrode spacing g by reduction of the number of radial electrodes going from outer rings to inner rings.

### Beam Steering

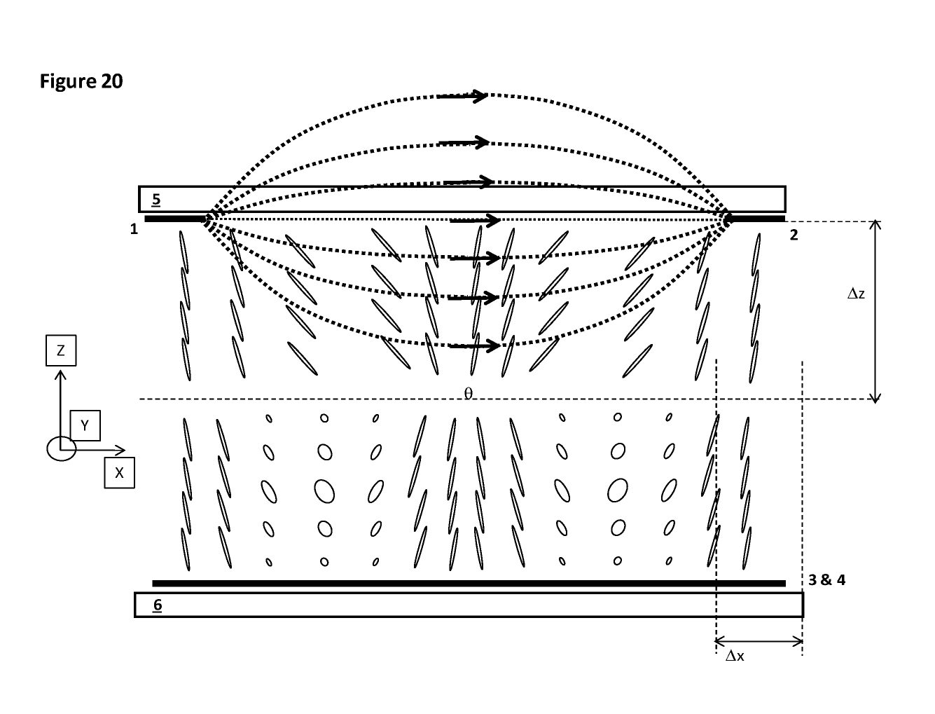

FIG. 20 describes very schematically an idealized geometry where both pairs of electrodes (1 & 2 on top substrate 5 and 3 & 4 on bottom substrate 6) are activated simultaneously with a relative phase shift of 180 degrees.

Instead of simultaneous activation of the two electrode arrangements, it is possible to alternate or time multiplex between activation of the upper and lower electrode arrangements.

It is important to mention that the molecular orientation pattern is illustrated in FIG. 20 is only to demonstrate qualitatively the concept of polarization rotation and transformation. In no way this is a limiting description. In this geometry, the immediate molecular surfaces will remain in the ground state (homeotropic) when strong anchoring conditions are present (not shown here). The homeotropic alignment will remain the same also in the immediate vicinity (below) of each electrode 1, 2 since the horizontal (or parallel to the substrates) components of electric fields are negligible (see extreme left and right columns of liquid crystal molecules, the zones denoted by Greek letters α, β, χ and δ). The situation may be similar in the center of the LC cell at least for moderate strength electric fields. However, the homeotropic alignment will be greatly perturbed in other zones. Namely, the main (not all) reorientation of molecules in the upper zone (between electrodes 1 and 2) will be in the plane of drawing (x-z) since the “closest” electrode pair 1 and 2 is parallel to the y axis. In contrast, the main (not all) reorientation of LC molecules in the lower zone (between electrodes 3 and 4) will be in the y-z plane that is perpendicular to the plane of drawing since the “closest” electrode pair 3 and 4 is parallel to the x axis.

However, of particular interest is the zone surrounding the area denoted by the letter θ that is between the above mentioned zones. In fact, there transition zones are expected at transitions from liquid crystal orientation from the plane x-z to the plane y-z. The physics of twisted liquid crystal cells was intensively studied in the literature for liquid crystal displays (see, e.g., C. H. Gooch and H. A. Tarry, “The Optical Properties of Twisted Nematic Liquid Crystal Structures with Twist Angles ≤90°”, J. Phys. D; Appl. Phys., Vol. 8, 1975). It was already established that if the twisting period P and the effective anisotropy Δn_{eff} are large enough then the input light polarization may be rotated with the twist of liquid crystal molecules as the light beam propagates through the LC material.

In accordance with embodiments of the proposed solution, devices described herein are configured to operate with (dramatically) changed operation principles (physical mechanism) to provide simplifications in the construction of practical devices. Namely, with reference to FIG. 20 an incident probe beam of arbitrary polarization enters the LC cell from the side of the top substrate 5 (propagating in −z direction) traversing the device towards the bottom substrate 6). The incident beam polarization may be presented as a sum of two linear polarization components Ex and Ey (parallel to x and y axes, respectively). The electrode strips 1 and 2 are parallel to the y axis, while the electrode strips 3 and 4 are parallel to the x axis. If electrodes 1 and 2 are activated, then the activation will create a molecular reorientation (schematically shown in the upper part of the FIG. 20, denoted by Δz). The input linear polarization component Ex, the extraordinary polarization, will then be broadened in the x-z plane due to the “upper” layers (slices) of the non-uniformly reoriented liquid crystal molecules. However, in addition, this polarization component may be rotated (as well as partially changing its polarization state) along its further propagation towards the bottom substrate 6 if the electrodes 3 and 4 are also simultaneously activated. In fact, in this configuration, the lower part of the LC cell by enlarge has more or less similar reorientation of LC molecules (as in the zone Δz) but in the perpendicular plane. However, the central zone (at the level of the letter θ in FIG. 20) the two zones (upper and lower areas of LC molecular orientations in more or less perpendicular planes) most likely create a transition zone with molecular twist. If the parameters of the LC cell, its reorientation and the wavelength range of light are appropriately chosen, then the linear polarization component Ex will arrive at substrate 6 with rotated and transformed polarization mainly being parallel to the y axis.

Due to this polarization rotation and transformation, the same polarization component Ex will reach the area affected by electrodes 3 and 4 as mainly a polarization that is perpendicular to the electrode lines 3 and 4. Thus, it will be also broadened in the plane y-z.

At the same time, the input polarization component Ey will mainly remain “unaffected”. It will enter into the LC cell as mainly “ordinary” type of polarization and will also undergo polarization rotation (with some partial change of the degree of polarization also) to reach electrode strips 3 and 4 still as “ordinary” polarization. Thus, the LC cell will not affect the input polarization that was originally parallel to the y axis.

The simultaneous activation and phase shift between electrodes enable employing a single liquid crystal cell to broaden a given linear polarization component of light in two (azimuthal) planes. This type of the LC cell enables the construction of a full-polarization operational device (broadening unpolarised light in two azimuthal planes) by just adding another similar (as described herein with reference to FIG. 20) LC cell (element) to the first LC cell. In addition, this may be achieved without using any polarization rotation element (since the liquid crystal itself is used to rotate the light polarization). Indeed, the addition of a second similar LC cell (the “entrance/input side” electrode pairs of the second LC cell being crossed with respect to the “exit/output side” electrode pairs of the first LC cell) and the progression of main polarization and broadening states are schematically presented in the FIG. 21 which describes schematically an idealized geometry where both pairs of electrodes (1 & 2 on top substrate 5 and 3 & 4 on bottom substrate 6) are activated with relative phase shift of 180 degrees.

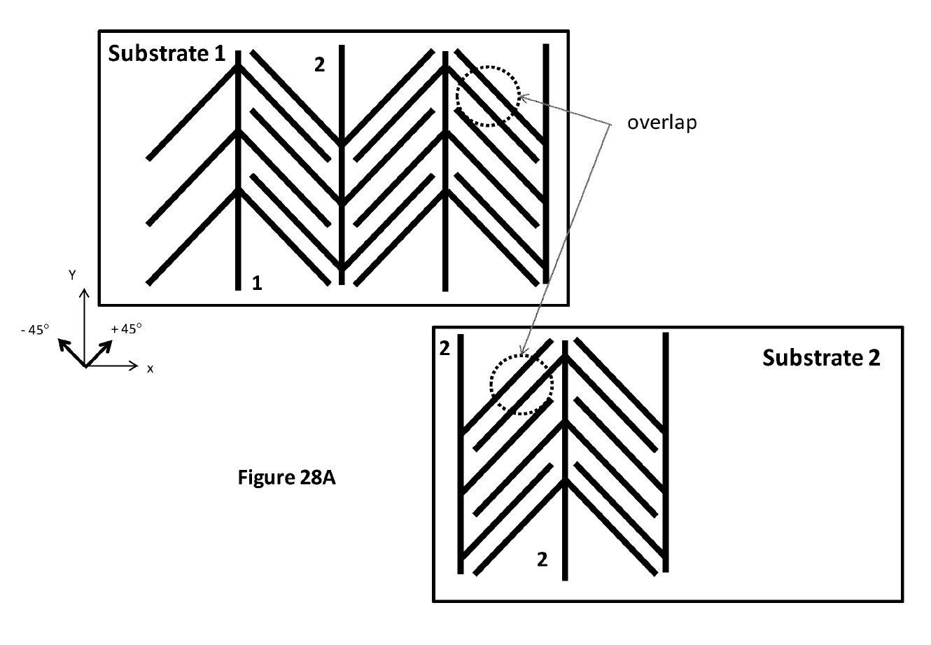

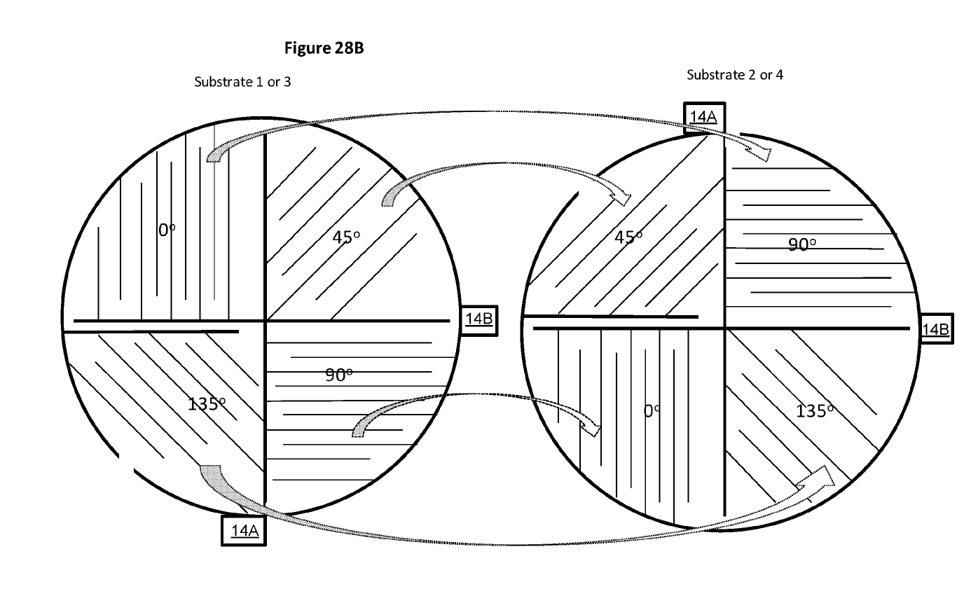

Applicant has discovered that the beam broadening is not symmetrical in X and Y directions in the geometry shown in FIG. 21. This is related to the asymmetry of the geometry, namely, the broadening in Y direction, defined by substrate 1 (for E1 polarization) and substrate 3 (for E2 polarization), which affects mainly the incident half of the propagation path of the light within the device, and the broadening in the X direction, defined mainly by substrate 2 (for E1 polarization) and substrate 4 (for E2 polarization), which affects mainly the outgoing half of the propagation path of light within the device, do not have the same efficiency. This asymmetry can be corrected using special intergititated electrode patterns where all (1, 2, 3 and 4) substrates participate in both X and Y broadening directions equally. This can be achieved for example by designing of paired sets of intergititated electrodes on the same substrate, each set of electrodes being orthogonal to the other one. Such a design is shown in, without limiting the invention thereto, in FIGS. 28A and 28B as described hereinbelow.

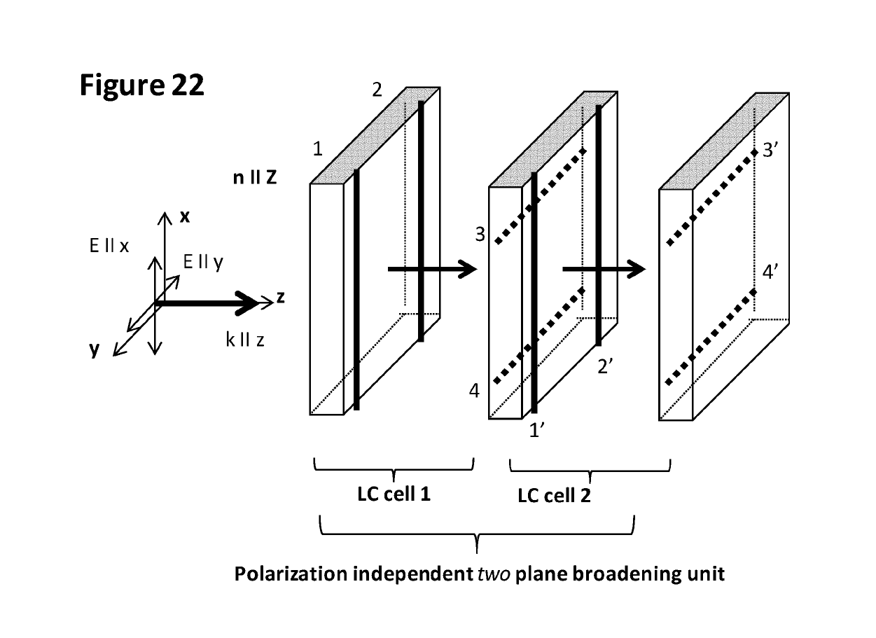

The fact that there is no need for a polarization rotation element and no need for rubbing of the homeotropic (or vertical) alignment layers (7, 18) simplifies greatly the manufacturing of such a beam control device which enables employing only three substrates and only four electrode layers, as shown in the example in FIG. 22 illustrating a low cost polarization insensitive light beam broadening element (for two azimuthal planes).

While linear strip electrodes 1, 2, 3, 4 (14A, 14B) can be used to provide beam control elements that are straight; zigzag patterns, sinusoidal patterns, spirals, concentric (FIGS. 14A and 14B), radial (FIGS. 15A and 15B) and other geometric patterns can be used. Regular spacing or a “chirping” variation in the spacing between electrodes can be used (see FIG. 13).

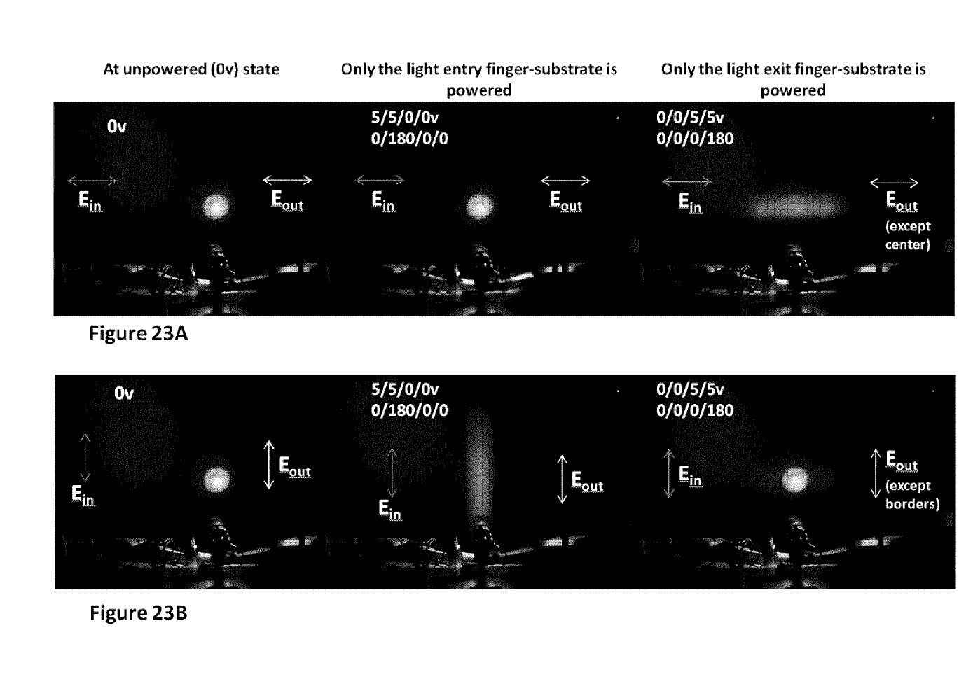

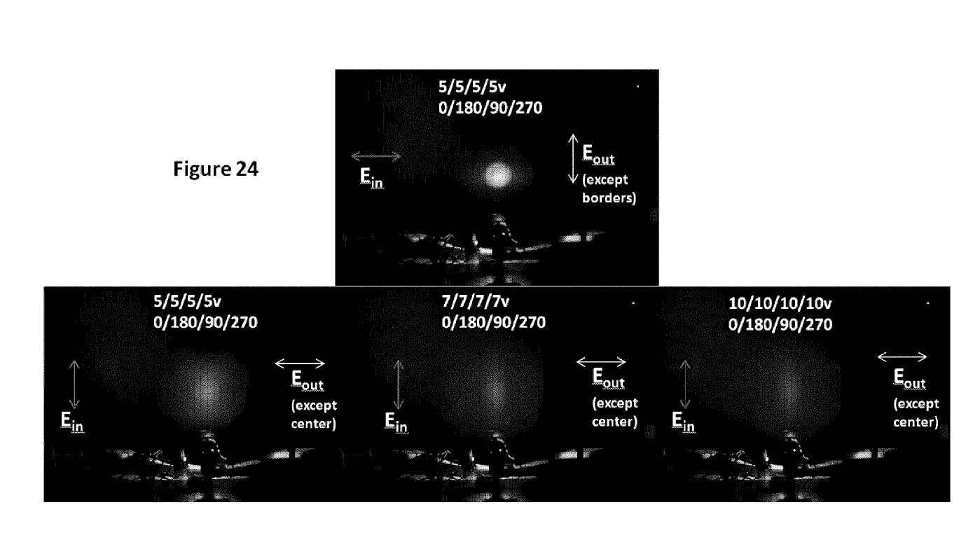

Experimental confirmation is demonstrated with success in FIG. 23A, FIG. 23B and FIG. 24, where there is no polarization rotation when only one pair of electrodes is activated (either 1 & 2 in FIG. 23A and 3 & 4 in FIG. 23B) and when there is a polarization rotation when both pairs of cross oriented electrodes are activated simultaneously (FIG. 24). When both finger-like electrodes on corresponding substrates are simultaneously driven: 90° rotation is observed, all-direction (two azimuthal plane) broadening for one polarized component (with the second polarization component remaining largely unchanged), and providing good rectangular pattern of a broadened light beam (projection).

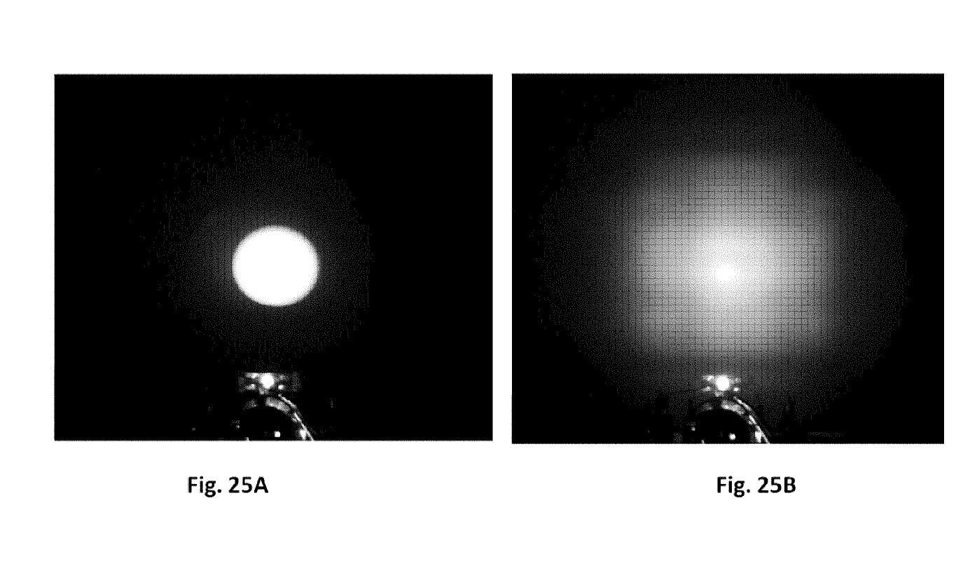

FIGS. 25A and 25B illustrate experimental demonstration of the importance of having independent electrodes and applying thereto corresponding drive signal components having (appropriate) selected phase delays therebetween to obtain useful acceptable light beam broadening. In FIG. 25A all electrodes are driven at 5V in phase, while in FIG. 25B all electrodes are driven with 5V drive signals however the signal phases are provided with 0, 180, 90 and 270 degree delays.

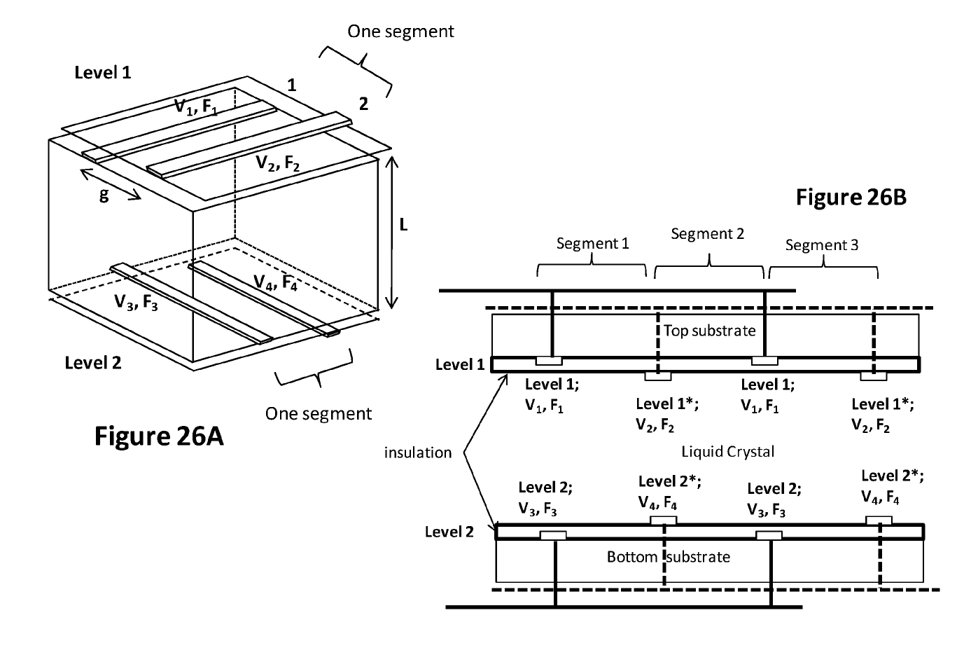

In another embodiment of the proposed solution, similar performance may be achieved by using two layers of electrodes (separated by a thin insulating layer) to build independently controllable electrode pairs for example as schematically illustrated in FIGS. 26A and 26B. Manufacturing yield may be increased since the overall device would still have large working surface despite the presence of some defects of lithography at a given sub layer. For example, shorts or cuts of neighboring electrode lines at a given layer will not prohibit the propagation of the electric voltage in that layer.

In another embodiment of the proposed solution, the unit LC cell, described in FIG. 20 can be replaced by a twisted (90 degree or multiples) liquid crystal layer. In such configuration, the polarization rotation will be ensured (right) from the outset at the ground state.

In another embodiment of the proposed solution, the unit LC cell, described in FIG. 20 can be replaced by a LC cell with hybrid alignment liquid crystal layer (planar alignment in one surface and homeotropic alignment on the opposed surface). In such configuration, the beam control device can broaden an unpolarised light beam in a given (azimuthal) plane if all electrodes (on the entrance and exit substrates) are parallel.

In another embodiment of the proposed solution, two LC cells will be spatially shifted with respect to each other and preferably in the diagonal direction (with respect to electrode lines). Such a configuration avoids the coincidence of zones where the reorientation of molecules is not appropriate (such as disclination regions). For example, employing homeotropic alignment (FIG. 20), LC molecules tend to remain homeotropic just under (adjacent to) the electrodes. If such disclination regions register (are the same for both) between LC cells, then the light passing through such disclination zones will not follow the same mechanism.

In another embodiment of the proposed solution, a small (separation) distance may be considered between the two unit LC cells which can improve the light intensity distribution.

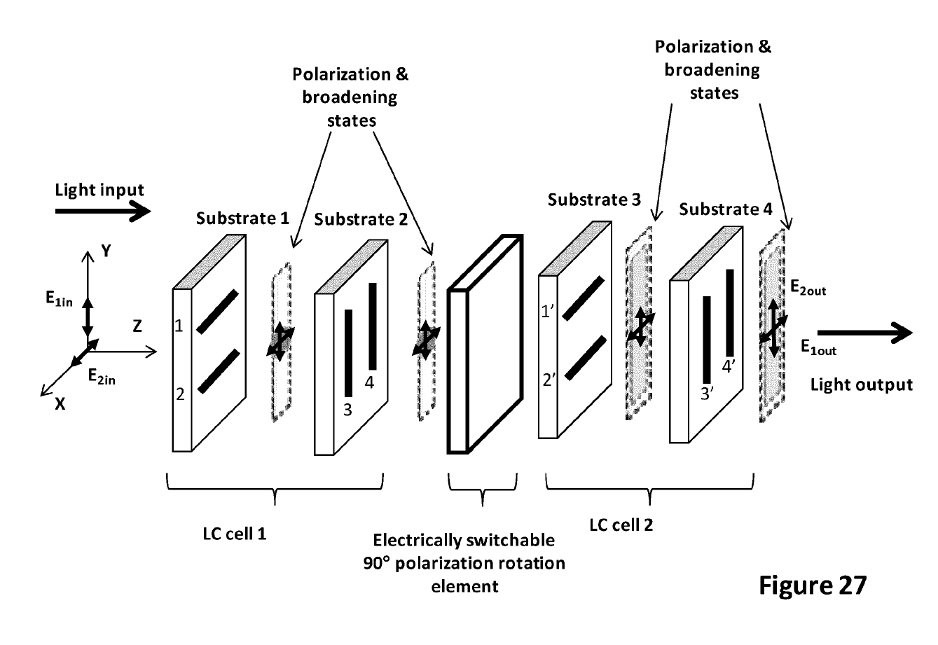

In another embodiment of the proposed solution, an electrically variable (switchable) polarization rotation element can be employed (such as a standard twisted liquid crystal cell) between two unit LC cells to enhance the device operational capabilities. FIG. 27 schematically demonstrates such a beam control device which is capable of broadening unpolarised light in one desired (azimuthal) plane only (or in the perpendicular azimuthal plane) and/or double broadening of the desired polarization component of light while the other (perpendicular) component remains substantially unaffected.

For example, consider the application in which it is desired to broaden an unpolarised light beam (which contains two light polarization components at the input of the device; E₁ᵢₙ and E₂ᵢₙ, parallel to y and x axes, respectively) in the plane z-y (FIG. 27). In this configuration, selectively activating the electrodes 1 and 2 (deposited on glass substrate 1) and keeping electrodes 3 and 4 (deposited on glass substrate 2) non-activated, will bring to the broadening of light component E₁ᵢₙ in the plane z-y while the component E₂ᵢₙ will remain essentially unaffected. Given that the electrodes 3 and 4 are not activated, the liquid crystal alignment close to the glass substrate 2 remains homeotropic. No polarization rotation is provided and both polarization components exit from the LC cell 1 (the glass substrate 2) with their original orientations (the E₁ᵢₙ being broadened in the in the plane z-y). The polarization components output from LC cell 1 are rotated at 90 degrees when crossing the corresponding element that is placed between the glass substrates 2 and 3 such that the original polarization component E₂ᵢₙ enters into the second LC cell being perpendicular to the electrodes 1′ and 2′ (deposited on the glass substrate 3). Repeating the same procedure (activating electrodes 1′ and 2′; and keeping the electrodes 3′ and 4′ passive) this polarization component is broadened in the same plane z-y plane. At the same time, the original E₁ᵢₙ component (already broadened in the first LC cell) passes through the second LC cell essentially unaffected. Broadening of two input polarization components (of natural light) is obtained in the plane y-z. It will be appreciated that both polarization components can be broadened in the perpendicular plane (x-z) if electrodes 3 and 4 as well as 3′ and 4′ are activated while keeping the electrodes 1 and 2 and 1′ and 2′ passive or un-activated.

The same beam control device could be used also in a mode where the polarization rotation element is switched off (and thus is not performing/providing polarization rotation). In this configuration, the application of the above mentioned procedure almost doubles the beam broadening effect for a given input polarization while the perpendicular light polarization would remain essentially unaffected.

With reference to FIG. 27, a single homeotropic LC cell with “excited” twisted molecular reorientation (when all electrodes on opposed substrates are activated simultaneously and independently with different phase control signals) can be used to broaden unpolarized (natural) light in two (azimuthal) planes. This can be provided by employing different zones spread over the clear aperture of the beam control device enabling control of different polarizations in different planes. As it can be appreciated from FIG. 28A, the electrode pairs may be etched (or printed) in a “tree-like” manner to have interdigitated electrodes 1 and 2, which are still locally parallel while their orientation alternates on 90 degrees from zone to zone.

The same pattern may be etched or printed on the opposed surface (on the second glass substrate), however during the cell assembly glass substrate 2 would be shifted with respect to the first glass substrate, such that the two encircled zones face each other with electrodes on the glass substrate 2 being perpendicular to electrodes of glass substrate 1 in the zone.

FIG. 28B illustrates another geometry with four sets of intergititated electrodes, in which two pairs of electrodes are twisted by 45 degrees in respect to the others. This additionally will improve the broadened light uniformity by smoothening the cross like pattern observed for incident low divergence light beams.

The LC cell may be filled, for example, by a homeotropically aligned liquid crystal (without rubbing). In this configuration, locally, the encircled zone (and others by analogy) act like in the configuration where linear interdigitated electrode pairs were pointing in a given direction on the first substrate and the same pattern, but turned at 90 degrees is employed on the second substrate. Such a single LC cell provides beam broadening of light with an input polarization that is perpendicular to the electrodes (at the first “entrance” glass substrate) in the plane perpendicular to those electrodes and the same light will be broadened in the perpendicular plane near to the exit surface (after having its polarization rotated by 90 degrees). The same concept can be used with different types of electrode arrangements.

A camera or other sensing element may be employed along with a data processor to generate the (drive) control signal(s) and change the divergence or the direction of the transmitted light.

The beam controller can be configured to receive control commands over a data network to adjust the beam broadening and/or direction. Some light sources, for example infrared light sources, can be used to provide data communication, and in this case the beam controller can be used to modulate the light source with data, while the dynamic LC control element can be used to steer and/or broaden/focus the data-carrying beam.

It will be appreciated that beam control in accordance with the different operational states is provided by electronic drive signal circuits that provide the respective drive signals to the electrode pairs. It will also be appreciated that such drive signal circuits can be controlled using suitable controller interfaces. In one non-limiting example, such controller interfaces can include controls associated with a light switch used to power the light source whose light is modulated by the LC device. Control data can be communicated to the drive signal circuit by any suitable data link, such as powerline data communications, free-space optical communications, RF wireless (WIFI, Bluetooth, etc.) and a wired data link to name a few. The controller can be a wall mounted device, an infrared or wireless RF remote control device, or an app on a smartphone to name a few options. The controller can be used to specify the beam control parameters such as one or more of beam breadth in each direction, beam direction in one or two directions, beam intensity and beam color.

While the invention has been illustrated and described with reference to preferred embodiments thereof, it will be recognized by those skilled in the art that various changes in form and detail may be made therein without departing from the spirit and scope of the invention as defined by the appended claims.

1. A beam control device for shaping an output light beam, the beam control device being configured to receive an incident beam from a light source, the beam control device comprising:
at least one liquid crystal cell for modulating said incident beam as said incident beam propagates therethrough, each liquid crystal cell having: a pair of cell substrates separated by a cell thickness, a liquid crystal material filling, at least one alignment layer for ordering said liquid crystal material with a director in a ground state alignment direction, and a patterned electrode structure having a pattern of paired electrodes on at least one of said pair of substrates for providing a spatially modulated electric field extending into said liquid crystal material, said liquid crystal cell having a predetermined aspect ratio between an electrode spacing gap between said paired electrodes and said cell thickness;
said beam control device being characterized by a spatially modulated director reorientation when said patterned electrode structure is driven by a predetermined drive signal that provides said output beam that is broadened with good uniformity and low color separation, and by any one or any combination of the following:
said beam control device is arranged for said initial beam to enter a first one of said at least one liquid crystal cell by one of said substrates having said pattern of paired electrodes thereon, and said alignment layer provides an in-plane liquid crystal ground state alignment;
said alignment layer provides in-plane liquid crystal alignment having an alignment direction that is between about 45 degrees to 0 degrees with respect to an orientation of said electrodes in said electrode pairs;
at least a pair of alignment layers, each said alignment layer orienting said liquid crystal director with negative and positive pre-tilt out-of-plane angle on said opposed substrates, said patterned electrode structure being provided on both cell substrates and the beam control device performing in a symmetric manner irrespective of the substrate receiving said incident beam;
said patterned electrode structure comprises two electrically insulated electrode patterns having corresponding electrode pairs arranged substantially orthogonally to one another for providing beam shaping control in two directions or azimuthal planes;
said alignment layer provides in-plane liquid crystal alignment having an alignment direction that is about 45 degrees with respect to the orientation of said electrode pairs, and four of said liquid crystal cells are combined to provide modulation of both polarizations and in two directions or azimuthal planes;
at least two of said liquid crystal cells combined to provide output beam modulation in two directions or azimuthal planes, said beam control device is arranged such that said incident light beam enters a first one of said liquid crystal cells by one of said substrates having said patterned electrode structure thereon, said alignment layer of said first liquid crystal cell provides in-plane liquid crystal alignment, said beam control device is arranged for said beam output by said first liquid crystal cell to enter said second one of said liquid crystal cells by one of said substrates without said patterned electrode structure, said alignment layer of said second liquid crystal cell provides homeotropic liquid crystal alignment;
a pair of said liquid crystal cells are combined with another pair of said liquid crystal cells having a 90 degree polarization rotator element therebetween for beam modulation in two directions or azimuthal planes and both light polarizations;
at least two of said liquid crystal cells are combined and share a common intermediate substrate that is a sandwich of two substrates having facing sides each of which carries said electrode pattern covered by insulation and bonded together, said two substrates sandwich preferably being chemically thinned to reduce a thickness thereof without disrupting the electrode patterns;
said liquid crystal cell substrates containing a liquid crystal material, a first patterned electrode structure on said first one of said substrates having first independent electrodes for providing a first in-plane electric field at said first one of said substrates and a first spatial modulation of the liquid crystal material in a first zone near said first substrate and between said first independent electrodes of said first patterned electrode structure, and a second patterned electrode structure arranged at a cross-orientation with respect to said first patterned electrode structure on a second one of said substrates and having second independent electrodes for providing a second in-plane electric field at said second one of said substrates and a second spatial modulation of the liquid crystal material in a second zone near said second substrate and between said second independent electrodes of said second patterned electrode structure, wherein when said first and said second patterned electrode structures are powered, a twist in liquid crystal orientation arises in a third zone between said first zone and said second zone over at least a portion of an aperture of said device to provide a polarization rotation in light passing through said device; and
said incident light beam having a divergence between ±3 degrees FWHM and ±15 degrees FWHM, preferably between ±4 degrees FWHM and ±8 degrees FWHM provided by at least one of:
an incident beam conditioning component including one of:
a convergence adding optical element when said light source comprises a divergent light source providing an initial beam divergence greater than ±8 degrees FWHM;
a divergence adding optical element when said light source comprises a collimated light source providing a; and
a dynamic diffuser; and
an output beam conditioning component including one of:
diffuser; and
a second one of said beam control devices oriented with respect to the first beam control devices at an angle between about ±2 degrees and about ±45 degrees.

2. A beam control device as defined in claim 1, wherein said electrode pattern comprises concentric rings.

3. A beam control device as defined in claim 2, further comprising a complementary orthogonal electrode pattern of radially extending electrode pairs.

4. A beam control device as defined in claim 1, wherein said aspect ratio of said electrode spacing gap to said cell thickness is between about 0.8 and about 1.3.

5. A beam control device as defined in claim 1, wherein electrode spacing gap is one of substantially constant and chirped such that said aspect ratio of said electrode spacing gap to said cell thickness is between about 0.8 and about 1.3.

6. A beam control device as defined in claim 1, wherein said initial beam has a FWHM divergence of about ±5 degrees FWHM and said modulated beam has a FWHM divergence of about +/−30 degrees FWHM, said predetermined drive signal having a voltage less than 10V, and said good uniformity of said output beam including an intensity of said modulated beam as a function of angle varying less than 40% over about +/−30 degrees FWHM.

7. A beam control device as defined in claim 1, further comprising a drive signal source for generating said predetermined drive signal, said drive signal source being configured to provide a variable control over beam divergence.

8. A beam control device as defined in claim 1, further comprising a dynamic diffuser controller.

9. A beam control device as defined claim 7, wherein said beam control device is configured to control beam direction or divergence in one azimuthal plane.

10. A beam control device as defined in claim 7, wherein beam control device is configured to control beam directions or divergence in two azimuthal planes.

11. A beam control device as defined in claim 1, wherein said beam control device is configured to provide said modulated beam comprising two polarizations of light.

12. A beam control device as defined in claim 1, comprising two of said liquid crystal cell having liquid crystal for shaping light in two azimuthal planes and of both polarizations.

13. A beam control device as defined in claim 1, wherein said two liquid crystal cells are arranged so as to have their patterned electrode structures offset with respect to one another so that transition portions of said first and said second zones of one of said two liquid crystal cells do not register with transition portions of said first and said second zones of another of said two liquid crystal cells.

14. A beam control device as defined in claim 1, wherein at least one of said alignment layers provides a homeotropic ground state orientation to said liquid crystal material.

15. A beam control device as defined in claim 1, wherein said alignment layers provide an in-plane ground state alignment of said liquid crystal material at each surface of said substrates, an in-plane orientation of ground state alignment being crossed or orthogonal between said first and second substrates.

16. A beam control device as defined in claim 1, wherein said electrode pattern comprises parallel lanes with predetermined width and gap.

17. A beam control device as defined in claim 1, wherein said electrode pattern comprises concentric lanes with predetermined width and gap.

18. A beam control device as defined in claim 1, wherein said electrode pattern comprises lanes with spatially variable width and gap.

19. A beam control device as defined in claim 1, where at least two of said liquid crystal cells are combined and share a common intermediate substrate having the patterned electrodes on both of its surfaces.

20. A beam control device as defined in claim 1, where at least two of said liquid crystal cells are combined, further comprising an electrically switchable 90 degree polarization rotation element between the two cells and a polarization switch controller.

21. A controllable beam shape light source module comprising a beam control device as claim in claim 1, and a light source module providing said initial light beam, said light source module is one of a camera flash, an architectural, automobile or industrial lighting device.

22. A controllable beam shape light source module comprising a beam control device as claim in claim 1, and a light source module is a scanner light source.

23. A controllable beam shape light source module as defined in claim 21, wherein the light source comprises a light emitting diode or a laser diode.
